(19) United States
(12) Patent Application Publication
(10) Pub. No.: US 2016/0171933 A1
(43) Pub. Date: Jun. 16, 2016

(54) GATE DRIVER CIRCUIT, AND IMAGE DISPLAY APPARATUS INCLUDING THE SAME

(71) Applicant: JOLED INC., Chiyoda-ku, Tokyo (JP)

(72) Inventors: Hiroshi TAKAHARA, Osaka (JP); Hirofumi NAKAGAWA, Tokyo (JP)

(73) Assignee: JOLED INC., Chiyoda-ku, Tokyo (JP)

(21) Appl. No.: 14/904,790

(22) PCT Filed: Jul. 3, 2014
(86) PCT No.: PCT/JP2014/003554

§ 371 Date: Jan. 13, 2016

(30) Foreign Application Priority Data
Jul. 18, 2013 (JP) 2013-149857

(51) Int. Cl. G09G 3/32

(52) U.S. Cl. CPC G09G 3/3258; G09G 3/3291; G09G 2310/08; G09G 2300/0842; G09G 2300/0452

(57) ABSTRACT

A gate driver IC (i.e., gate driver circuit), when set to a first mode by a logic signal of the terminal FNC*, shifts data in the gate driver IC in synchronization with one clock cycle of a clock inputted to the terminal CLK** (clock input terminal), and outputs a selection voltage or a non-selection voltage based on a data position in the gate driver IC; and when set to a second mode by a logic signal of the tenninal FNC*, shifts data in the gate driver IC in synchronization with n clock cycles (n is an integer of at least 2) of a clock inputted to the terminal CLK**, and outputs the selection voltage or the non-selection voltage based on the data position in the gate driver IC.

### TECHNICAL FIELD

The present disclosure relates to an image display apparatus of an active-matrix type which includes a display screen in which pixels are disposed in a matrix, and a gate driver circuit for use in the image display apparatus.

### BACKGROUND ART

An electroluminescence (EL) display apparatus involves various pixel configurations, and the total number of gate signal lines per pixel varies. For that reason, there has been a need to develop gate driver integrated circuits (ICs) (i.e., gate driver circuits) respectively complying with the pixel configurations.

Each of the pixels includes a plurality of transistors. Furthermore, each of the pixels includes gate signal lines of different types for controlling each of the transistors in a pixel circuit. These gate signal lines include some with high load capacity and others with relatively low load capacity.

Furthermore, slew rates required of control signals to be applied to the respective gate signal lines also differ. For example, while the gate signal line through which a video signal voltage is supplied to a pixel requires a high slew rate, a relatively low slew rate is sufficient for the gate signal line that controls current which flows through the EL element.

For example, Patent Literature (PTL) 1 discloses an image display apparatus which includes two gate signal lines resulting from dividing a single gate signal line around the center thereof, and drives each of the gate signal lines by a corresponding driving circuit, which is a method of driving a gate signal line with high load capacity at a high slew rate. In addition, PTL 2 discloses an image display apparatus in which driving of gate signal lines is divided by gate driver circuits.

### CITATION LIST

### Patent Literature

### [PTL 1] Japanese Unexamined Patent Application Publication No. 2006-154822

### [PTL 2] Japanese Unexamined Patent Application Publication No. 2006-011095

### SUMMARY OF INVENTION

### Technical Problem

The present disclosure provides a gate driver IC (i.e., gate driver circuit) which is highly versatile and can be used irrespective of the number and arrangement of the gate signal lines and irrespective of the specification or the like of the image display apparatus, and an image display apparatus which includes the gate driver IC.

### Solution to Problem

A gate driver circuit according to an aspect of the present disclosure is a gate driver circuit included in an image display apparatus that includes a display screen in which pixels are disposed in a matrix, the gate driver circuit including: a clock input terminal; a data input terminal; a plurality of output terminals connected to gate signal lines of the image display apparatus; and a setting circuit for setting a first mode or a second mode, wherein a selection voltage or a non-selection voltage output from an arbitrary one of the plurality of output terminals is applied to a corresponding one of the gate signal lines, data set at the data input terminal is provided to the gate driver circuit according to a clock inputted to the clock input terminal, the data is shifted in the gate driver circuit in synchronization with the clock inputted to the clock input terminal, the arbitrary one of the plurality of output terminals outputs the selection voltage or the non-selection voltage based on a data position in the gate driver circuit, when the setting circuit is set to the first mode, the data is shifted in the gate driver circuit in synchronization with one clock cycle of the clock inputted to the clock input terminal, and the selection voltage or the non-selection voltage is output based on the data position in the gate driver circuit, and when the setting circuit is set to the second mode, the data is shifted in the gate driver circuit in synchronization with n clock cycles of the clock inputted to the clock input terminal, and the selection voltage or the non-selection voltage is output based on the data position in the gate driver circuit, n being an integer of at least 2.

### Advantageous Effects of Invention

According to the present disclosure, it is possible to provide a gate driver IC (i.e., gate driver circuit) which is highly versatile and can be used irrespective of the number and arrangement of the gate signal lines and irrespective of the specification or the like of the image display apparatus, and an image display apparatus which includes the gate driver IC.

### BRIEF DESCRIPTION OF DRAWINGS

FIG. 1 is a schematic diagram illustrating a configuration of an image display apparatus according to Embodiment 1.

FIG. 2 is a circuit diagram illustrating a pixel circuit of the image display apparatus.

FIG. 3 is a block diagram illustrating a configuration of a gate driver IC.

FIG. 4 is a configuration diagram of the image display apparatus on which the gate driver IC is mounted, according to Embodiment 1.

FIG. 5 is a diagram for explaining each of gate voltage binary driving and gate voltage ternary driving in the case of a P-channel transistor.

FIG. 6 is a diagram illustrating application of the gate voltage binary driving and the gate voltage ternary driving to gate signal lines.

FIG. 7 is a timing chart illustrating an operation of a scanning and outputting buffer circuit of the gate driver IC.

FIG. 8 is a timing chart illustrating an operation of the scanning and outputting buffer circuit of the gate driver IC.

FIG. 9 is a configuration diagram of the scanning and outputting buffer circuit.

FIG. 10 is a block diagram illustrating a configuration of a gate driver IC according to a modification of Embodiment 1.

FIG. 11 is a configuration diagram of the image display apparatus according to the present disclosure, on which the gate driver IC according to the modification of Embodiment 1 is mounted.

FIG. 12 is a timing chart illustrating an operation of a scanning and outputting buffer circuit included in the gate driver IC illustrated in FIG. 11.

FIG. 13 is a timing chart illustrating an operation of another scanning and outputting buffer circuit included in the gate driver IC illustrated in FIG. 11.

FIG. 14 is a timing chart illustrating an operation of the scanning and outputting buffer circuit included in the gate driver IC when an application period of Von is set to 2H.

FIG. 15 is a timing chart illustrating an example of an operation of the scanning and outputting buffer circuit included in the gate driver IC illustrated in FIG. 11.

FIG. 16 is a timing chart illustrating another example of an operation of the scanning and outputting buffer circuit included in the gate driver IC illustrated in FIG. 11.

FIG. 17 is a timing chart illustrating an operation of the scanning and outputting buffer circuit included in the gate driver IC when an application period of Von is set to 2H.

FIG. 18 is a circuit diagram illustrating a pixel circuit of an image display apparatus according to Embodiment 2.

FIG. 19 is a block diagram illustrating a configuration of the gate driver IC.

FIG. 20 is a configuration diagram of the image display apparatus on which the gate driver IC is mounted, according to Embodiment 2.

FIG. 21 is a circuit diagram illustrating a pixel circuit according to a modification of Embodiment 2.

FIG. 22 is a schematic diagram illustrating a configuration of an image display apparatus according to the modification of Embodiment 2.

FIG. 23 is a diagram for explaining each of gate voltage binary driving and gate voltage ternary driving in the case of an N-channel transistor.

FIG. 24 is a timing chart related to the N-channel transistor.

FIG. 25 is a timing chart related to the N-channel transistor.

FIG. 26 is a timing chart related to the N-channel transistor.

FIG. 27 is a timing chart related to the N-channel transistor.

FIG. 28 is a timing chart related to the N-channel transistor.

FIG. 29 is a timing chart related to the N-channel transistor.

FIG. 30 is a timing chart related to the N-channel transistor.

FIG. 31 is a timing chart related to the N-channel transistor.

FIG. 32 illustrates an external view of a display to which the image display apparatus according to the present disclosure is employed.

FIG. 33 illustrates an external view of a camera to which the image display apparatus according to the present disclosure is employed.

FIG. 34 illustrates an external view of a computer to which the image display apparatus according to the present disclosure is employed.

FIG. 35 is a block diagram illustrating a configuration of the gate driver IC according to a modification of Embodiment 1.

### DESCRIPTION OF EMBODIMENTS

(Underlying Knowledge Forming the Basis of the Present Disclosure)

Underlying knowledge forming the basis of the present disclosure is described below prior to describing details of the present disclosure.

As described above, a pixel includes gate signal lines each disposed for a corresponding one of transistors included in a pixel circuit. Accordingly the more the total number of the transistors per pixel circuit increases, the more the types of the gate signal lines increases. It should be noted that when the types of gate signal lines differ, the gate signal lines are applied with different pulses (voltage values for applying an ON voltage or an OFF voltage, time periods, cycles, etc.).

Furthermore, the total number of the gate signal lines per type is equal to the total number of the pixel circuits in a vertical direction. For example, the total number of the gate signal lines included in an image display element of Extended Graphics Array (XGA) is 768, and an image display element of Super-XGA (SXGA) is 1024. Thus, for example, the image display element of SXGA including four types of gate signal lines has in total 1024×4=4096 of the gate signal lines.

The image display apparatus includes gate signal line driving circuits for driving such a large number of the gate signal lines. The gate signal line driving circuits are integrated as the gate driver IC, and mounted near terminals of the gate signal lines drawn from the image display element.

However, in the case where both of the gate signal line to which the bilateral driving is applied and the gate signal line to which the bilateral driving is not applied (i.e., the gate signal line to which the unilateral driving is applied) are included, the number and the arrangement of the terminals of the gate signal lines drawn from one side of the image display element are, in general, different from the number and the arrangement of the terminals of the gate signal lines drawn from the other side of the image display element.

The image display apparatus including the EL element involves various pixel configurations, and the total number of the gate signal lines per pixel varies. For that reason, there has been a need to develop gate driver ICs respectively complying with the pixel configurations.

In addition, with different specifications or the like of the image display apparatus, the total number of pixels differs and the total number of transistors per pixel circuit also differs, and therefore the total number of gate signal lines to be driven differs as well. Furthermore, the total number of gate signal lines which should be driven through the bilateral driving also differs.

There is a problem that tremendous amounts of money and time are required for generating a dedicated gate driver IC according to the number and arrangement of the gate signal lines drawn from the image display element, and further according to the specifications or the like of the image display apparatus.

In view of the above, the inventors of the present disclosure has conceived an image display apparatus which includes a gate driver IC which is highly versatile and can be used irrespective of the number and arrangement of terminals of the gate signal lines and irrespective of the specification or the like of the image display apparatus.

Hereinafter, embodiments are described in greater detail with reference to the accompanying Drawings as necessary. However, description that is too detailed will be omitted in some cases. For example, there are instances where detailed description of well-known matter and redundant description of substantially identical components are omitted. This is for the purpose of preventing the following description from being unnecessarily redundant and facilitating understanding of those skilled in the art.

It should be noted that the accompanying Drawings and subsequent description are provided by the inventors to allow a person of ordinary skill in the art to sufficiently understand the present disclosure, and are thus not intended to limit the scope of the subject matter recited in the Claims.

### Embodiment 1

Hereinafter, Embodiment 1 shall be described with reference to the Drawings.

1-1 Configuration

1-1 Overall Configuration

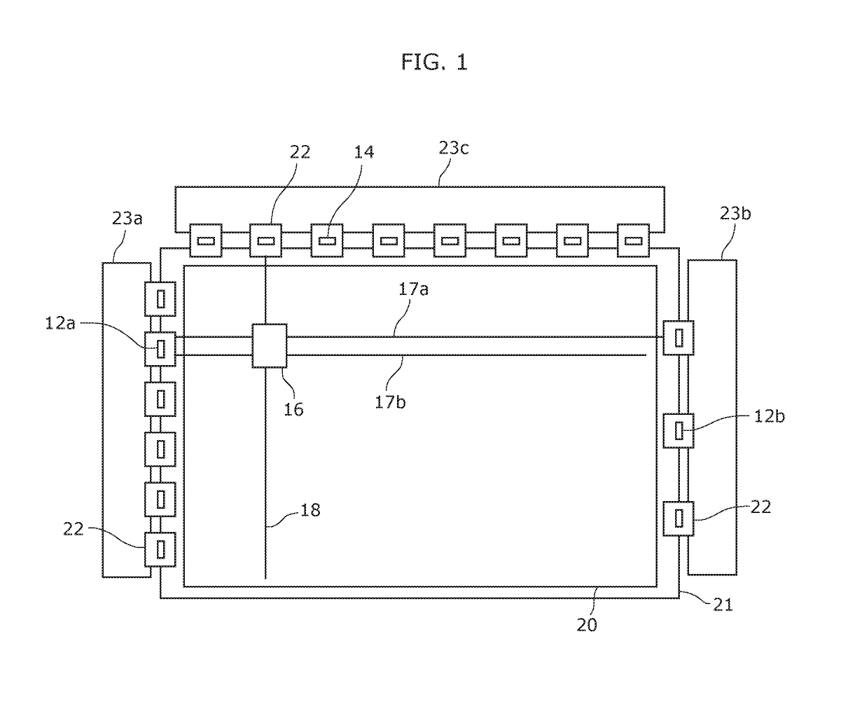

FIG. 1 is a schematic diagram illustrating a configuration of an image display apparatus according to Embodiment 1.

The image display apparatus illustrated in the diagram includes: a display panel 21 including a display screen 20; printed circuit boards 23a to 23c; COFs 22 which connect the display panel 21 and the printed circuit boards 23a to 23c. The display screen 20 includes pixels 16 each having an EL element are disposed in a matrix. The gate signal line 17a and the gate signal line 17b are connected to each of the pixels 16. The gate signal line 17a is connect to connecting terminals 35 of a gate driver IC 12a and a gate driver IC 12b which are mounted on the COFs 22. The gate signal line 17b is connected to the connecting terminal 35 of the gate driver IC 12a mounted on the COF 22.

A source driver IC (i.e., source driver circuit) 14 generates large amounts of heat, and thus a heatsink, a heat dissipation sheet, or a heat dissipation film is formed or disposed on the rear surfaces of the COFs. The heatsink, the heat dissipation sheet, or the heat dissipation film is directly or indirectly connected to the source driver IC 14.

In FIG. 1, the source driver IC 14 is also mounted on the COF 22. An output terminal of the source driver IC 14 is connected to the source signal line 18. The source driver circuit 14 applies a video signal or a video signal voltage to the source signal line 18.

It should be noted that the printed circuit board 23c illustrated in FIG. 1 is a printed circuit board on which a circuit for a video signal is formed or mounted. In addition, printed circuit boards 23a and 23b are printed circuit boards on each of which a circuit for scanning is formed or mounted.

Principle constituent elements of the image display apparatus shall be described below in detail.

1-1-2. Pixel

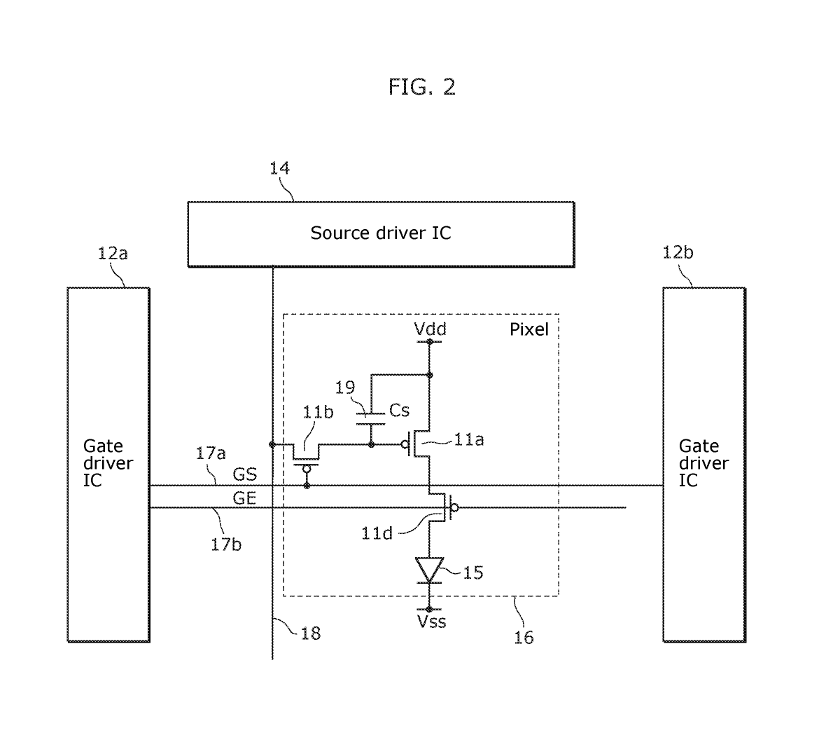

FIG. 2 is a circuit diagram illustrating a pixel configuration of the image display apparatus.

In the present disclosure, although a driving transistor 11 and a switching transistor 11 are described as thin-film transistors, the transistors are not limited to the thin-film transistors. The transistors can be formed of a thin-film diode (TFD), a ring diode, etc. as well. It should be noted that the driving transistor 11a, the switching transistor 11b, and the switching transistor 11d are also referred to as a transistor 11a, transistor 11b, and transistor 11d, respectively. Or, the driving transistor 11a, the switching transistor 11b, and the switching transistor 11d are not specifically distinguished and referred to as a transistor 11 in some cases.

In addition, the transistors are not limited to thin-film elements but may be transistors formed on silicon wafers. For example, a transistor formed using a silicon wafer, removed and transferred onto a glass substrate is exemplified. In addition, a display panel on which a transistor chip formed using a silicon wafer is mounted by bonding on a glass substrate is exemplified.

The transistor 11 may, of course, be an FET, a MOS-FET, a MOS transistor, or a bipolar transistor. These are also, basically, thin-film transistors. It should be understood that the transistor may be a varistor, a thyristor, a ring diode, a photodiode, a photo transistor, a PLZT element, etc.

In addition, it is preferable that a lightly doped drain (LDD) structure is employed for the transistor 11 according to the present disclosure, for both cases of an N-channel transistor and a P-channel transistor.

Furthermore, the transistor 11 may be formed using any of high-temperature poly-silicon (HTPS), low-temperature poly-silicon (LTPS), continuous grain silicon (CGS), transparent amorphous oxide semiconductors (TAOS, IZO), amorphous silicon (AS), and infrared rapid thermal annealing (RTA).

In FIG. 2, all of the transistors 11 included in a pixel are the P-channel transistors. However, the transistors 11 of the pixel are not limited to the P-channel transistors according to the present disclosure. All of the transistors 11 of the pixel may be the N-channel transistors. Furthermore, the transistors 11 may be composed of both of the N-channel transistor and the P-channel transistor.

It is preferable that the transistor 11 has a top gate structure. This is because the top gate structure reduces parasitic capacitance, and a gate electrode pattern of the top gate serves as a light shielding layer to shield light emitted from the EL element 15, making it possible to reduce malfunction of a transistor or an off-leakage current.

It is preferable, in the process to be carried out, that a copper line or a copper alloy line can be employed as a line material for the gate signal line 17 or the source signal line 18, or for both of the gate signal line 17 and the source signal line 18. This is because it is possible to reduce wiring resistance between the signal lines and to implement a larger EL display panel.

It is preferable that the gate signal line 17 which is driven (controlled) by the gate driver IC 12 has low impedance. Accordingly, the same holds true for a composition or a structure of each of the gate signal lines 17.

In particular, it is preferable that a low-temperature poly-silicon (LTPS) is employed. With the low-temperature poly silicon, the transistor has a top gate structure and small parasitic capacitance, and it is possible to manufacture the N-channel and P-channel transistors, and to use the copper line or the copper alloy line in the processes. It is preferable that, for the copper line, a three-layer structure of Ti—Cu—Ti is employed.

For the lines, it is preferable that a three-layer structure of molybdenum (Mo)—Cu—Mo is employed in the case of the transparent amorphous oxide semiconductors (TAOS).

In the image display apparatus according to the present disclosure, color filters including red (R), green (G), and blue (B) are formed so as to correspond to the positions of the pixels 16. It should be noted that the color filter is not limited to RGB, and a pixel including cyanogen (C), magenta (M), and yellow (Y) may be formed. Furthermore, a pixel of white (W) may be formed. More specifically, pixels of R, G, B, and W are disposed in the display panel 20 in a matrix.

Pixels are manufactured so as to be square with three pixels of RGB. Accordingly, each pixel of R, G, and B has an elongated pixel shape. It is thus possible to prevent characteristic variations among the transistors 11 in one pixel, by performing annealing with a laser irradiation spot being elongated.

It should be noted that R, G, and B may each have a different pixel aperture ratio. With the different aperture ratios, it is possible to have different current densities between currents flowing through the EL element 15 of the respective RGB. With the different current densities, it is possible to equalize the deterioration rate of the EL elements 15 of the RGB. With the same deterioration rate, white balance shift does not occur in the image display apparatus.

Furthermore, a white (W) pixel is formed, as necessary. In other words, a pixel includes R, G, B, and W. With R, G, B, and W being included, high-luminance can be obtained. In addition, a configuration including R, G, B, and G is also exemplified.

According to the present disclosure, a pixel including white (W) in addition to three primary colors of RGB is included. An excellent color peak luminance can be implemented by forming or disposing the pixel 16. In addition, high-luminance display can be implemented.

Colorization of the image display apparatus is performed by mask evaporation; however, colorization according to the present disclosure is not limited to the mask evaporation. For example, an EL layer which emits blue light is formed, and emitted blue light may be converted to light of R, G, and B, through a color conversion layer; that is, color change medium (CCM) of R, G, and B.

An electric field from each of the source signal line 18 and the gate signal line 17 is shielded by an anode electrode 40 or a cathode electrode, by disposing or forming the anode electrode 40 or the cathode electrode above the source signal line 18 and the gate signal line 17. It is possible, by the shield, to reduce noise in an image display.

An insulating film or an insulating film formed of an acrylic material (planarization film) is formed on the source signal line 18 and the gate signal line 17 to insulate the source signal line 18 and the gate signal line 17, and a pixel electrode 40 is formed on the insulating film.

As described above, the structure in which the pixel electrode 40 is stacked on at least part of the gate signal line 17, etc., is referred to as a high aperture (HA) structure. This structure reduces unnecessary interfering light or the like, and thus realizes an excellent light emitting condition.

It is possible to use a transparent electrode including, for example, ITO, indium (IGZO), gallium, zinc, oxygen, IZO, transparent amorphous oxide semiconductor (TAOS), or the like, for the pixel electrode of the pixel circuit 16.

It should be noted that a circularly polarizing plate (circularly polarizing film) (not illustrated) is disposed on the light emitting face of the image display apparatus. A polarization plate and a phase film are integrated into a circularly polarizing plate (circularly polarizing film).

The display apparatus according to an aspect of the present disclosure includes: the display screen 20 including EL elements disposed in a matrix; the gate signal lines 17 disposed for each pixel row of the display screen; the source signal line 18 disposed for each pixel column of the display screen; the gate driver circuits (gate driver ICs) 12 which drive the gate signal lines 17; and the source driver IC (source driver circuit) 14 which drives the source signal line 18.

It should be noted that the source driver IC (circuit) 14 may have a multi-delay function which enables setting an output timing of a video signal for each terminal or for each block.

FIG. 2 illustrates a pixel configuration in which the switching transistor 11d is disposed in a current pathway of current generated by the driving transistor 11a. The current generated by the driving transistor 11a is supplied to the EL element 15, and the EL element 15 emits light with luminance proportional to the supplied current.

The switching transistor 11b has a function of applying, to the driving transistor of the pixel 16, a video signal voltage generated by the source driver IC 14 and applied to the source signal line 18. The capacitor 19 has a function of holding the applied video signal for one frame period.

As illustrated in FIG. 2, the gate driver IC 12a and the gate driver IC 12b are connected to the ends of the gate signal line 17a. Only the gate driver IC 12a is connected to the gate signal line 17b.

The gate signal line 17a which drives the transistor 11b that applies a video signal voltage (video signal) to the pixel 16 is connected to the gate driver IC 12a and the gate driver IC 12b. For example, the gate driver IC 12a is disposed on the left side of the display screen 20, and the gate driver IC 12b is disposed on the right side of the display screen 20.

The following describes the reason why two gate driver ICs 12 (12a and 12b) are disposed for the gate signal line 17a. It should be noted that there are instances where the gate driver ICs 12a and 12b are not specifically distinguished and referred to as the gate driver ICs 12.

The gate signal line 17a is connected to the transistor 11b. The transistor 11b is a transistor for writing a video signal onto the pixel 16, and thus it is necessary to turning ON and OFF the transistor 11b at high speed (high slew rate operation). The high slew rate operation can be implemented by driving the gate signal line 17a with the two gate driver ICs 12 (12a and 12b).

The gate signal line 17a is driven by the two gate driver ICs 12, thereby eliminating, for example, luminance inclination of the right and left sides with respect to the center of the display screen 20 and implementing an excellent image display. In addition, even when the load capacities of the gate signal lines 17 are large, it is possible to smoothly drive the gate signal lines 17.

As described above, the gate signal line 17a is connected to the switching transistor 11b which applies a video signal to the pixel 16. Accordingly, the gate signal line 17a is applied with the bilateral driving by the two gate driver ICs 12.

In contrast, the switching transistor 11d has a function of interrupting current flowing through the EL element 15, and it is not necessary to perform the operation of interrupting current at high speed. Accordingly, high slew rate operation is not necessary, and thus the switching transistor 11d is applied with the unilateral driving by only the gate driver IC 12a.

The image display apparatus according to the present embodiment includes the display screen 20 including a plurality of EL elements 15. In addition, the image display apparatus includes, as peripheral circuits of the display screen 20, the gate driver ICs 12 which drive the gate signal lines 17, the source driver IC 14 which generates and outputs video signals, and a control circuit (not illustrated) which controls the gate driver ICs 12, etc.

The display screen 20 includes the EL elements disposed in a matrix. The display screen 20 displays an image according to a video signal inputted to the image display apparatus from an external source.

1-1-3. Gate Driver IC

1-1-3-1. Detailed Configuration

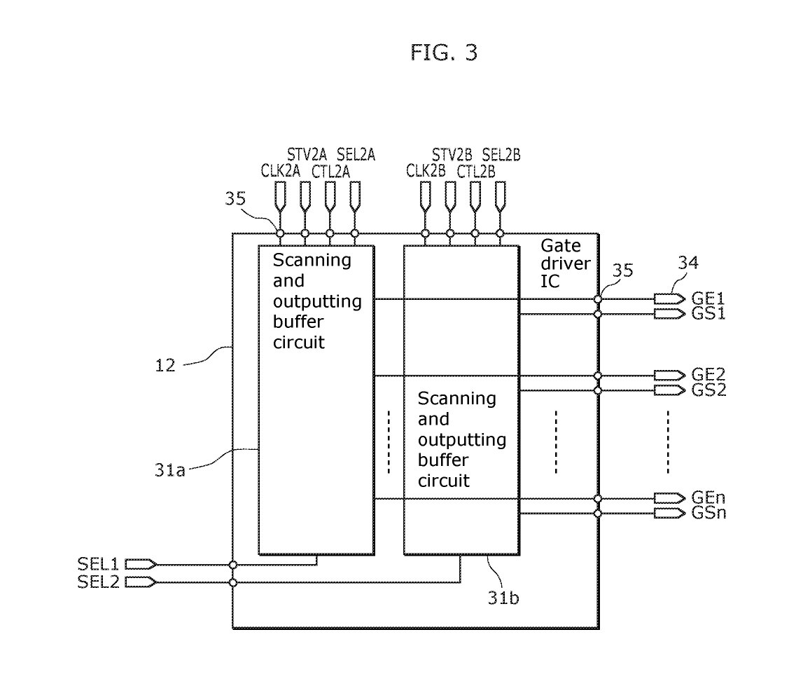

As described above, the gate driver ICs 12a and 12b apply the bilateral driving to the gate signal line 17a, and the unilateral driving to the gate signal line 17b. FIG. 3 is a block diagram illustrating a configuration of the gate driver ICs 12.

As illustrated in FIG. 3, the gate driver ICs 12 each include a plurality of scanning and outputting buffer circuits 31. Each of the gate driver ICs 12 is a driving circuit which is connected to the gate signal lines 17, and has a function of controlling conduction (ON, selection) and non-conduction (OFF, non-selection) of the switching transistors 11 (11b and 11d) included in the EL element 15, by outputting a selection signal to the gate signal lines 17. It should be noted that there are instances where the scanning and outputting buffer circuits 31a and 31b are not specifically distinguished from each other and described simply as scanning and outputting buffer circuits 31.

The gate driver ICs 12 (gate driver ICs 12a and 12b) are disposed on the left side and the right side of the display screen 20, and the gate signal lines 17 of each of the pixels 16 is connected to at least the gate driver IC 12a or the gate driver IC 12b.

In particular, the gate signal line 17a (gate signal line GS) is connected to both of the gate driver ICs 12.

The gate driver ICs 12 are capable of outputting voltages of three different values (Von, Voff1, and Voff2) from the output terminals 34. In addition, it is possible to set an output mode (gate voltage binary driving) for outputting voltages of two different values (Von and Voff1) and an output mode (gate voltage ternary driving) for outputting voltages of three different values (Von, Voff1, and Voff2), using selection signal line (terminal SEL).

The settings using the terminal SEL can be performed for each of the scanning and outputting buffer circuits 31 formed or disposed in the gate driver ICs 12.

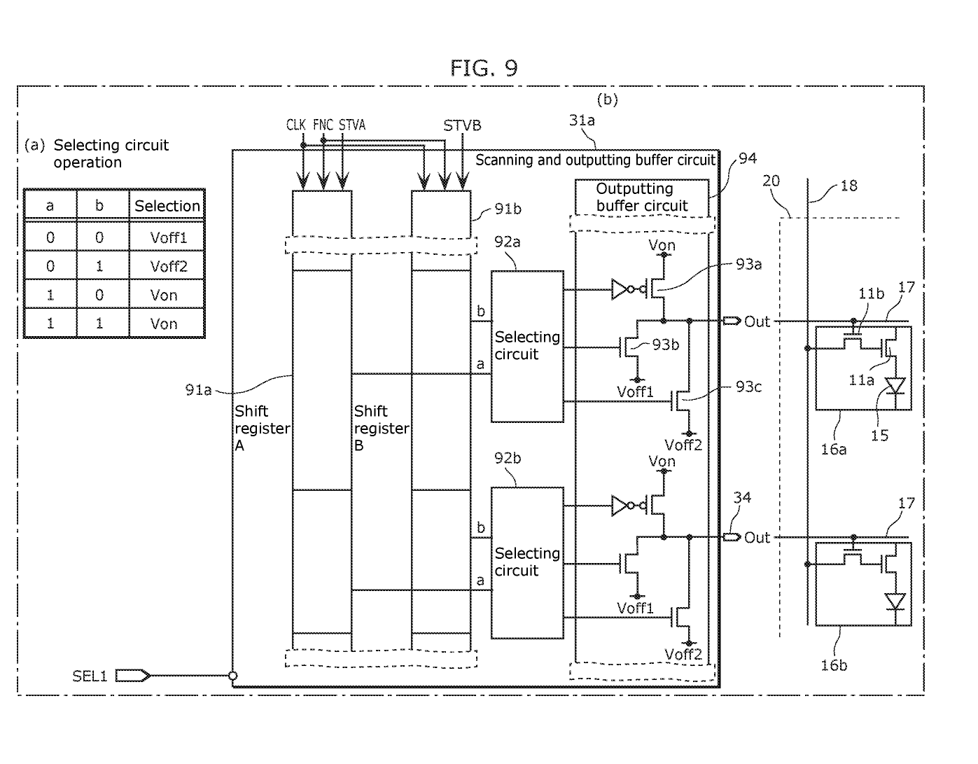

The gate driver ICs 12 each include two scanning and outputting buffer circuits 31. The scanning and outputting buffer circuits 31 are each mainly composed of a shift register circuit and an outputting buffer circuit (see FIG. 9). It should be noted that although the scanning and outputting buffer circuits 31 each mainly composed of the shift register circuit and the outputting buffer circuit, the shift register circuit and the outputting buffer circuit may be separately disposed or formed, or a plurality of shift register circuits may be formed and a single outputting buffer circuit which amplifies or buffers outputs of the plurality of shift register circuits may be formed or disposed. In addition, it should be understood that the outputting buffer circuit may be omitted when the shift register circuits are capable of sufficiently driving the respective gate signal lines 17.

It should be noted that the scanning and outputting buffer circuits 31 are described in an embodiment of the present disclosure, however, the shift register circuit and the outputting buffer circuit are not limited to this. The shift register circuit and the outputting buffer circuit are not necessarily integrated, and may be separately disposed. According to an embodiment of the present disclosure, the circuit is not limited to the shift register circuit, but any circuit may be employed as long as the gate driver circuit or the like which can apply a selection voltage or a non-selection voltage is connected to one gate signal line and the circuit has a function of selecting an intended gate signal line. In addition, the shift register circuit is not limited to a shift register circuit having a shift register function, but may be a decoder circuit which, for example, selects a gate signal line based on k-bit data. Furthermore, the gate driver circuit according to an embodiment of the present disclosure includes a plurality of shift register circuits, etc., and is capable of selecting a shift register circuit, etc. from among the plurality of shift register circuits, etc., and the gate signal lines 17 in a pixel row different from pixel rows of the another shift register circuits.

The scanning and outputting buffer circuit 31a applies a selection voltage (ON voltage) or a non-selection voltage (OFF voltage) to the gate signal line 17a (gate signal line GS).

The scanning and outputting buffer circuit 31b applies the selection voltage (ON voltage) or the non-selection voltage (OFF voltage) to the gate signal line 17b (gate signal line GE).

The scanning and outputting buffer circuits 31 include terminals to which a clock signal is inputted (CLK2A and CLK2B), terminals to which a data signal (start pulse) is inputted (STV2A and STV2B), terminals to which a logic signal for selecting between the binary voltage driving and the ternary voltage driving (SEL2A and SEL2B), and terminals to which a control signal is inputted (CTL2A and CTL2B). Terminals CTL2A and CTL2B have a function of controlling an output state of the scanning and outputting buffer circuits 31.

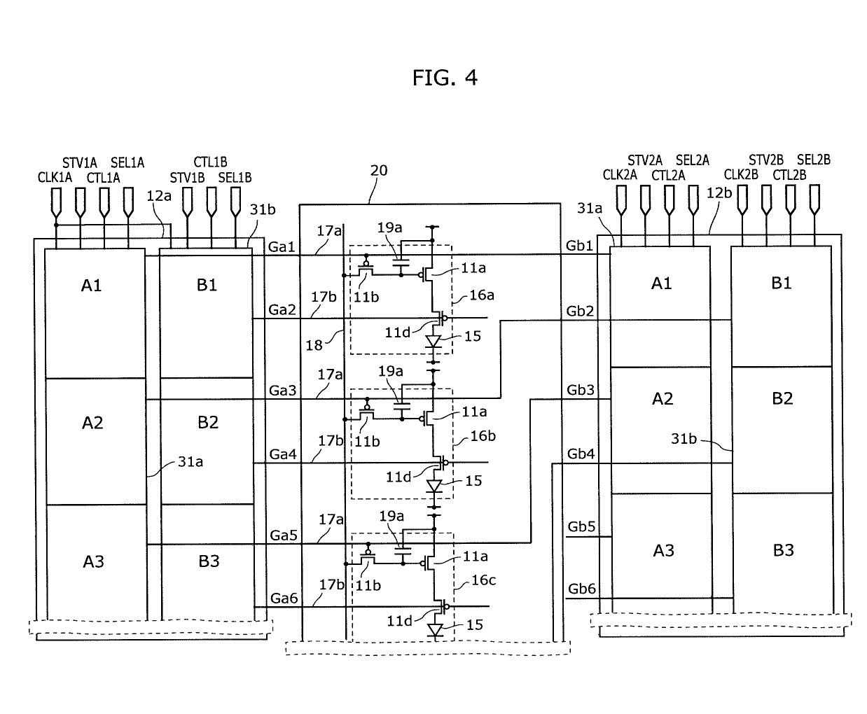

It should be noted that the numerical values assigned to the terminals are provided for descriptive purposes. The numerical values may be any values as long as terminal names are explicitly described as illustrated in FIG. 4 and the like.

Terminals STV** (STV2A and STV2B) are data input terminals, and data which has been inputted to the terminals are inputted to the shift registers with rise of a clock inputted to terminals CLK** (CLK2A and CLK2B).

The terminals CLK** (CLK2A and CLK2B) are clock input terminals, and the data in the shift register circuits is shifted in synchronization with the clock inputted to the terminals.

1-1-3-2. Binary Driving and Ternary Driving

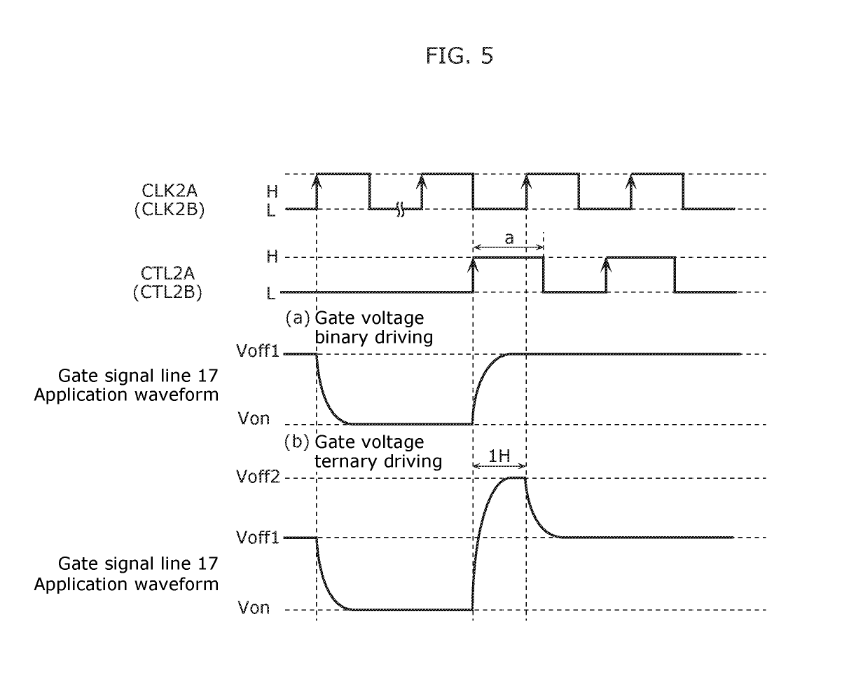

Terminals SEL** (SEL2A and SEL2B) are terminals for switching between the gate voltage binary driving and the gate voltage ternary driving illustrated in FIG. 5. The gate voltage ternary driving is selected when the logic data inputted to the terminals SEL** (SEL2A and SEL2B) is “H”. The gate voltage binary driving is selected when the logic data inputted to the SEL** terminals (SEL2A and SEL2B) is “L”. The ternary driving is applied to the gate signal lines 17 which require a high slew rate, and the binary driving is applied to the gate signal lines 17 which do not require the high slew rate. The gate signal line 17a which requires the high slew rate is applied with the ternary driving, and the gate signal line 17b which does not require the high slew rate is applied with the binary driving.

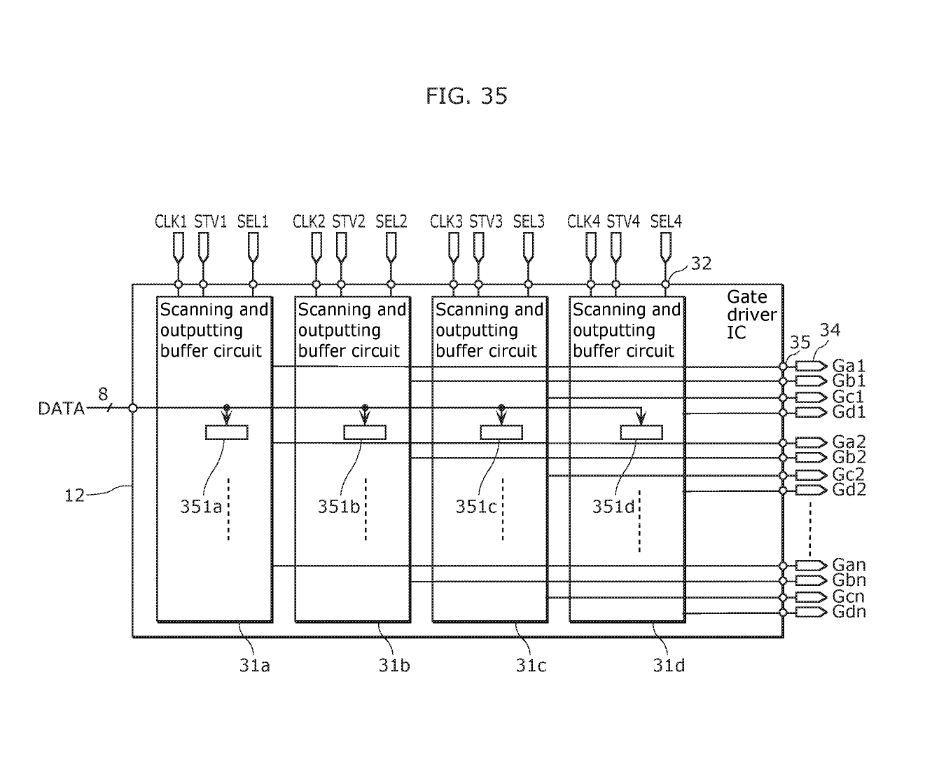

For example, selection between the gate voltage ternary driving and the gate voltage binary driving is implemented in a hardware manner based on the logic voltage provided to the input terminal disposed or formed on the gate driver ICs 12. Alternatively, selection between the gate voltage ternary driving and the gate voltage binary driving is implemented by a software process performed based on a command inputted to the gate driver ICs 12. For example, as illustrated in FIG. 35, DATA is inputted to the gate driver IC 12 as a command from outside, and the input DATA is converted to a setting command in command decoder circuits 351a to 351d to set an operation or a function. It should be noted that there are instances where the command decoder circuits 351a to 351d are not specifically distinguished from each other and described as command decoder circuits 351.

The gate voltage binary driving is a mode in which a selection voltage (Von voltage, i.e., ON voltage) and a first non-selection voltage (Voff1 voltage or OFF voltage 1) are applied to the gate signal lines 17.

The gate voltage ternary driving is a mode in which a selection voltage (Von voltage, i.e., ON voltage), the first non-selection voltage (Voff1 voltage, i.e., OFF voltage 1), and a second non-selection voltage (Voff2 voltage, i.e., OFF voltage 2) are applied to the gate signal lines 17. A period in which the second non-selection voltage (Voff2 voltage) is applied to the gate signal lines is one horizontal scanning period (period of 1H), or a period in which one pixel row is selected or shorter. A period in which the ON voltage is applied is set as an arbitrary period greater than or equal to the period of 1H, based on the data applied to the terminals STV** (STV2A and STV2B).

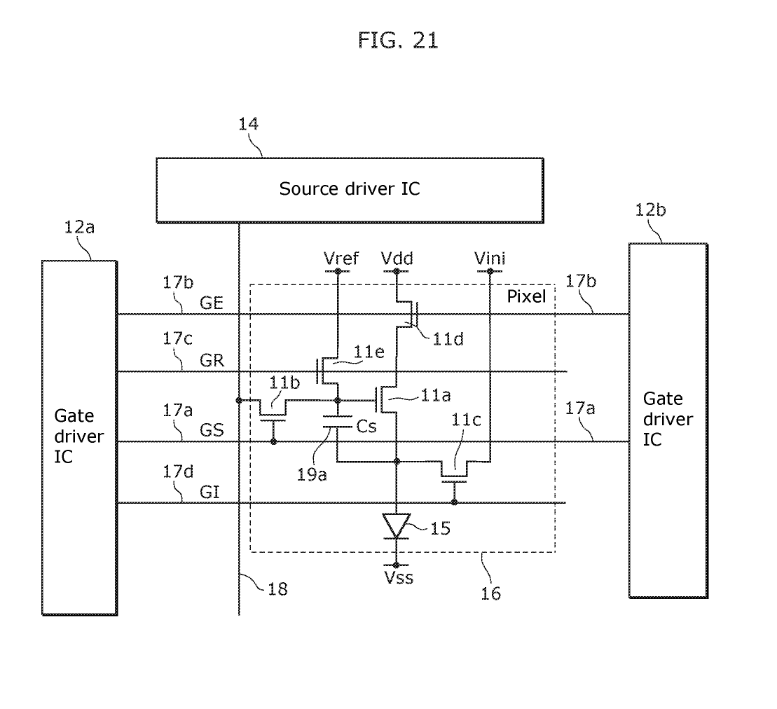

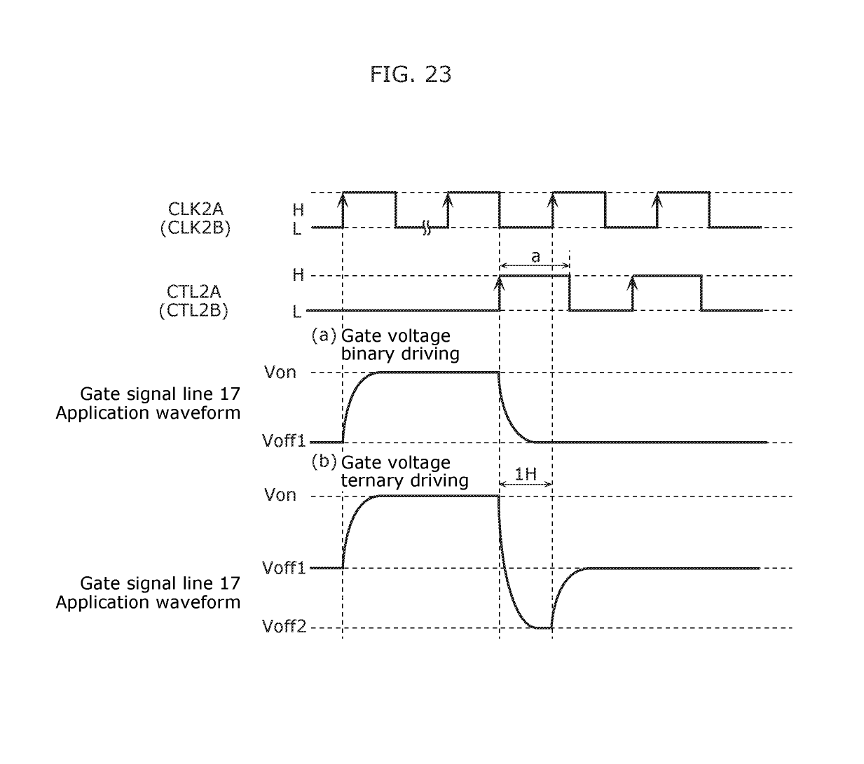

It should be noted that FIG. 5 is a timing chart illustrating the voltage binary driving and the voltage ternary driving in the case where the switching transistor 11b is a P-channel transistor as in FIG. 2. In contrast, in the case where the switching transistor 11b is an N-channel transistor as in FIG. 21, the voltage polarity is inverted as illustrated in FIG. 23.

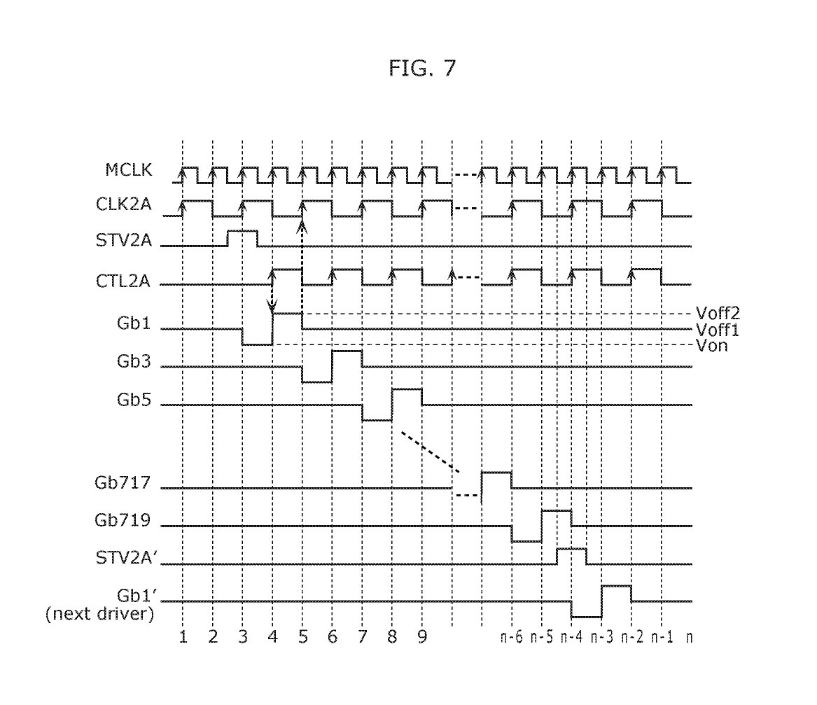

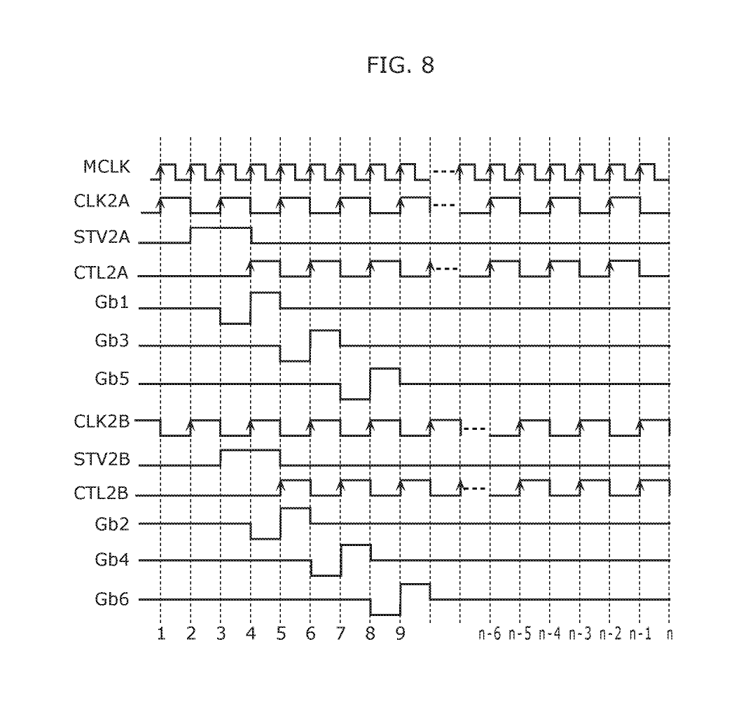

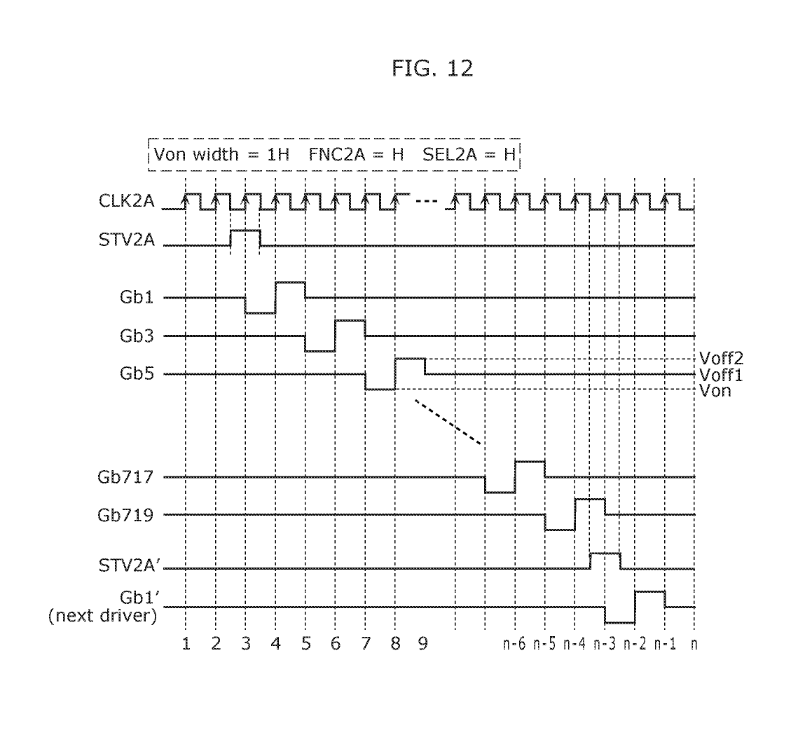

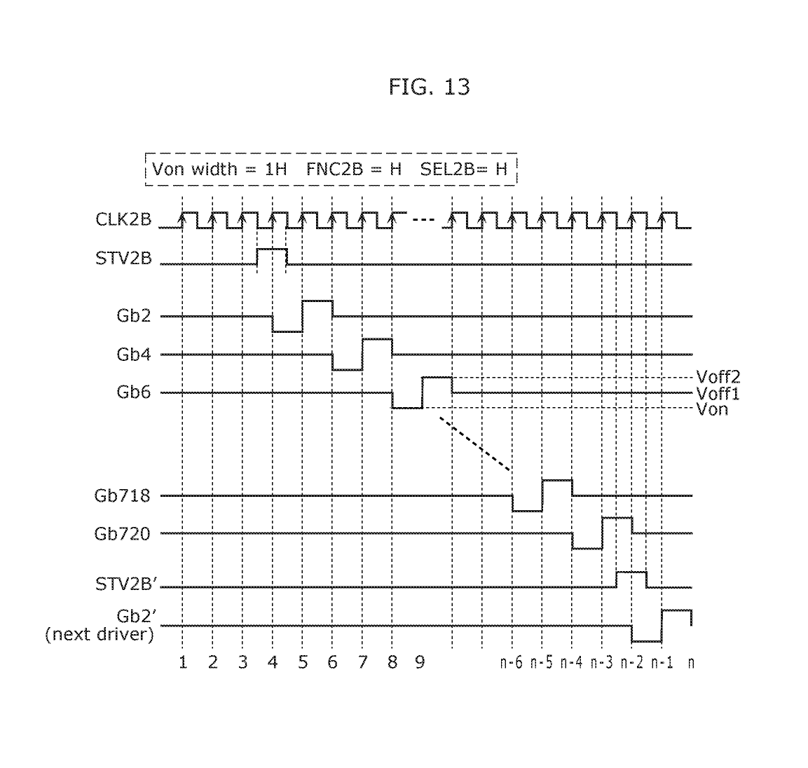

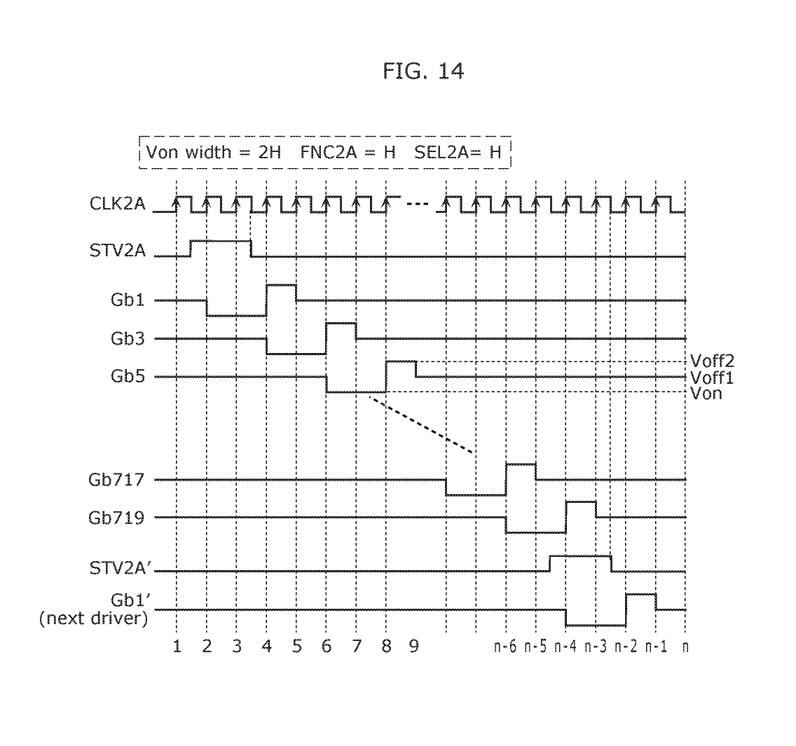

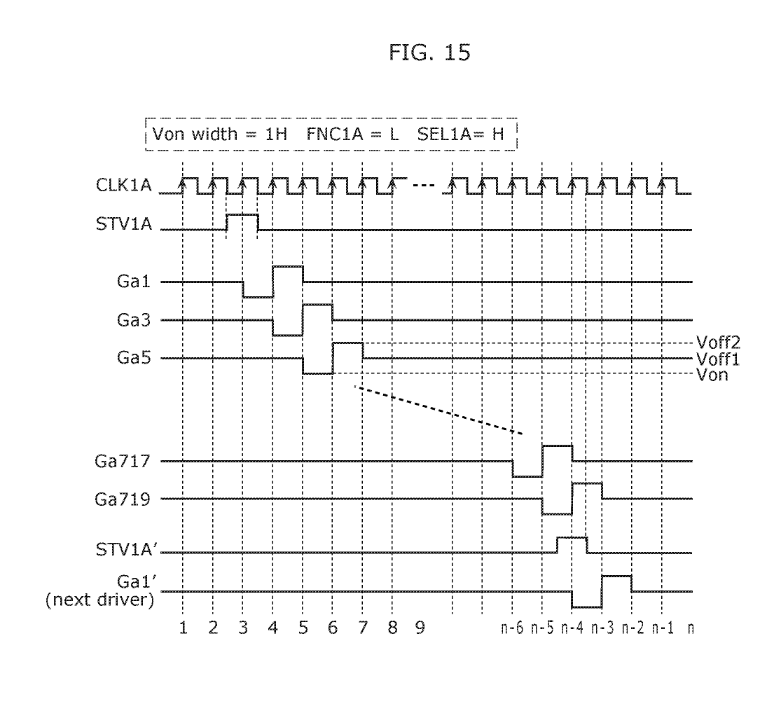

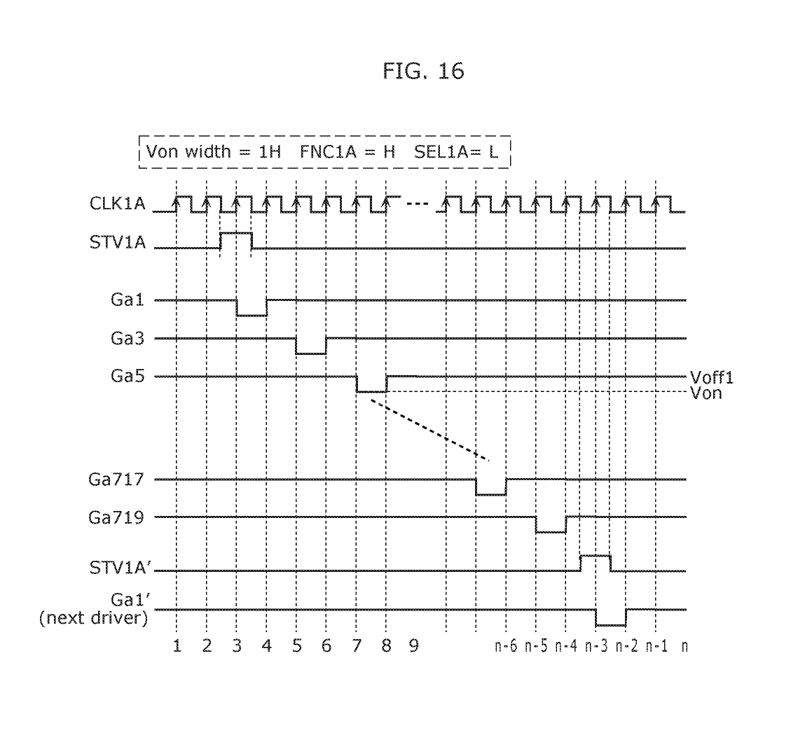

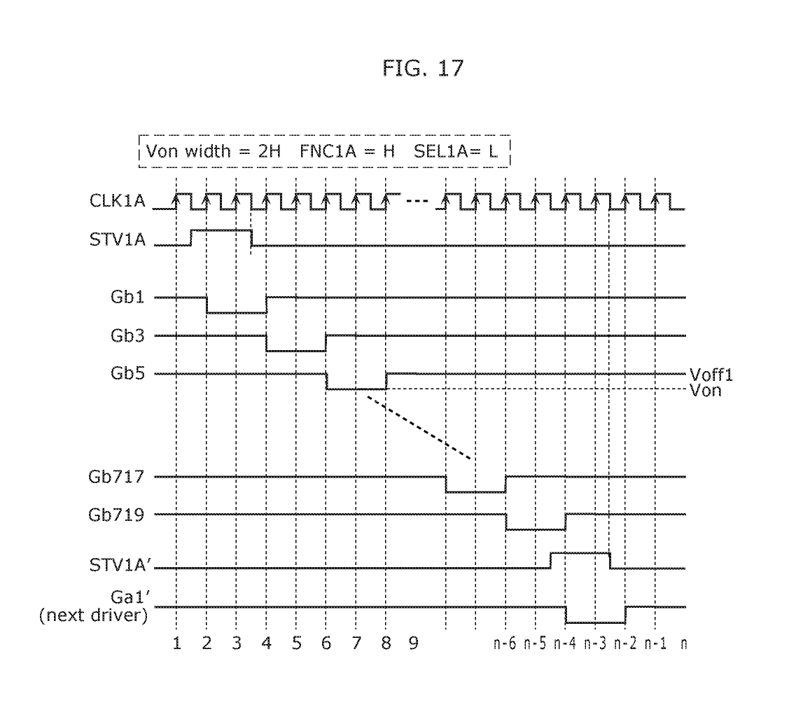

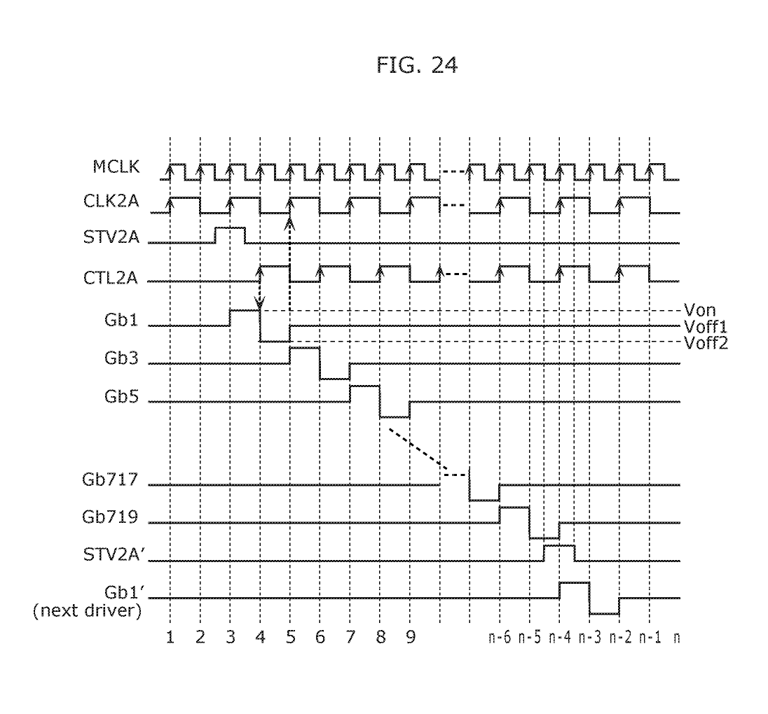

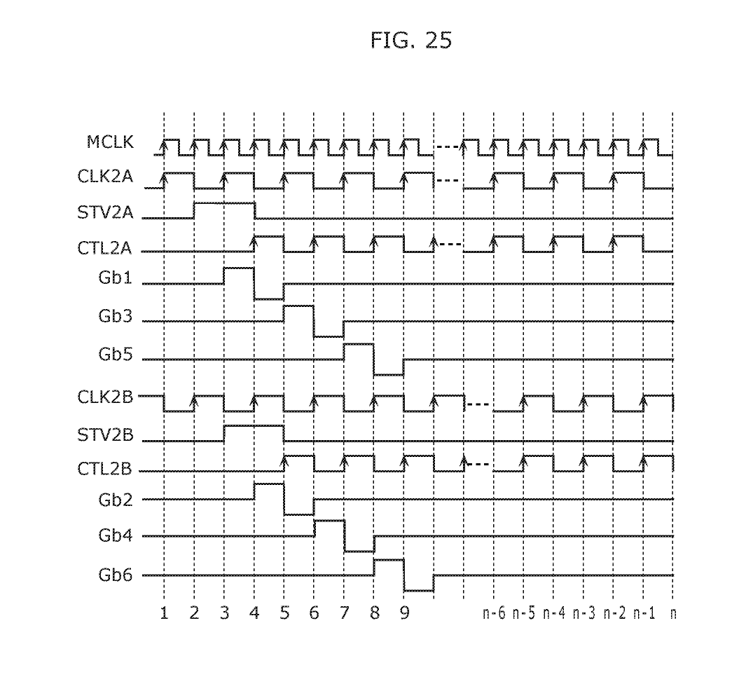

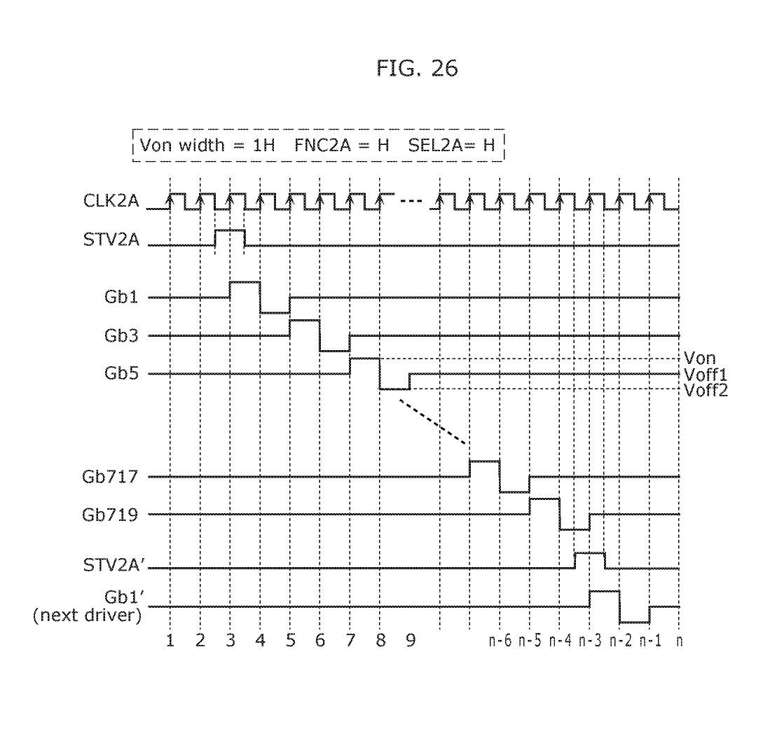

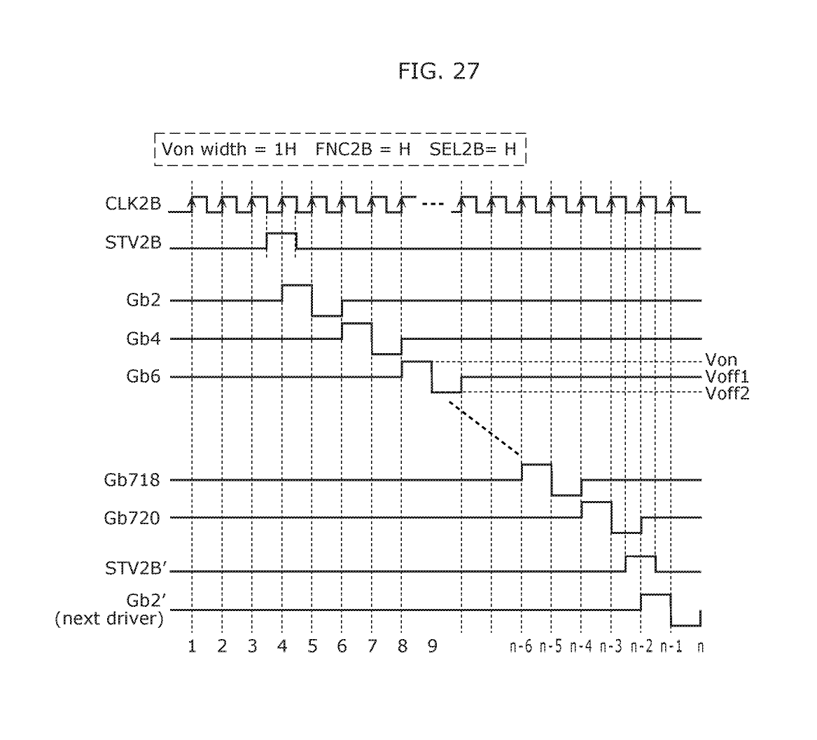

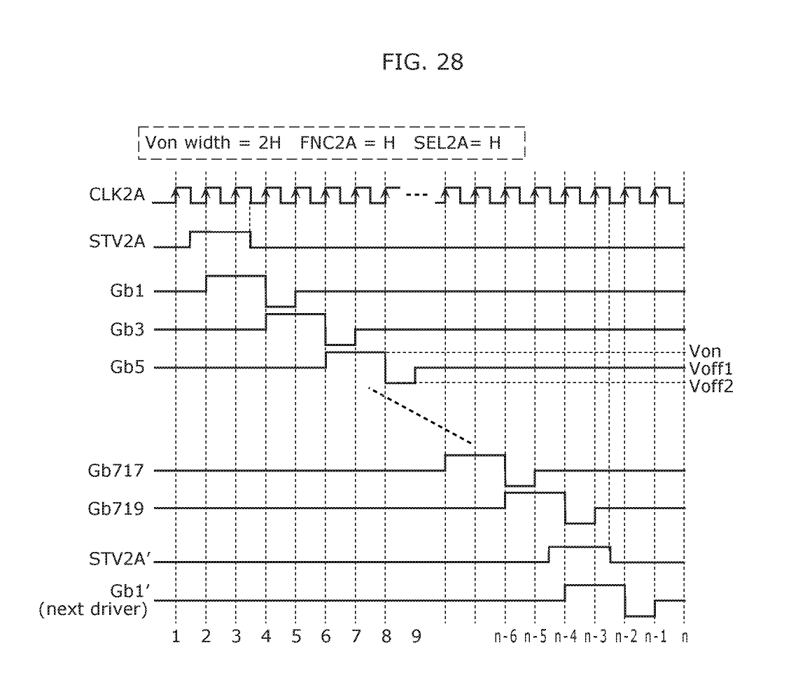

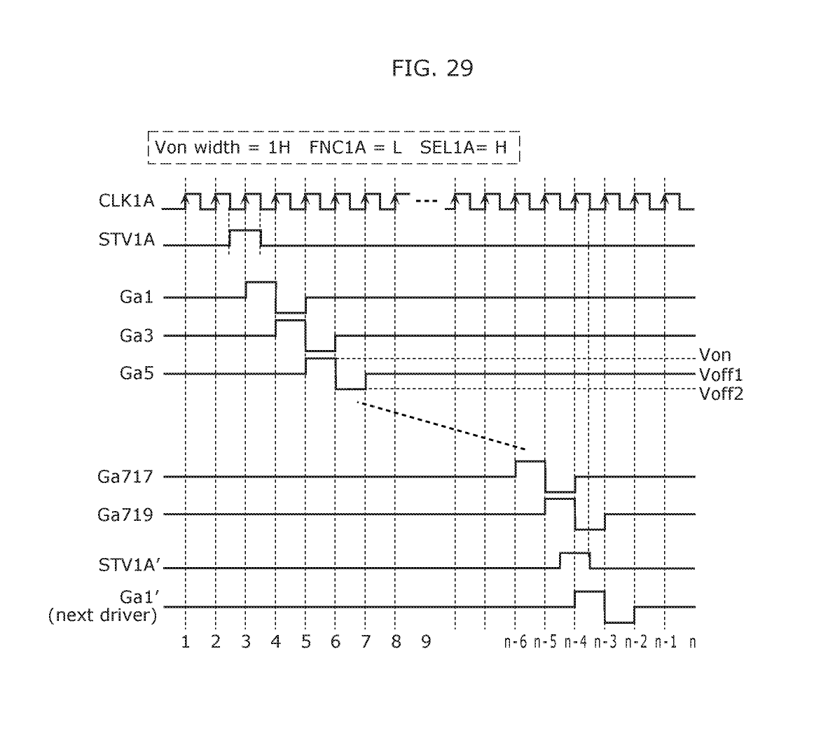

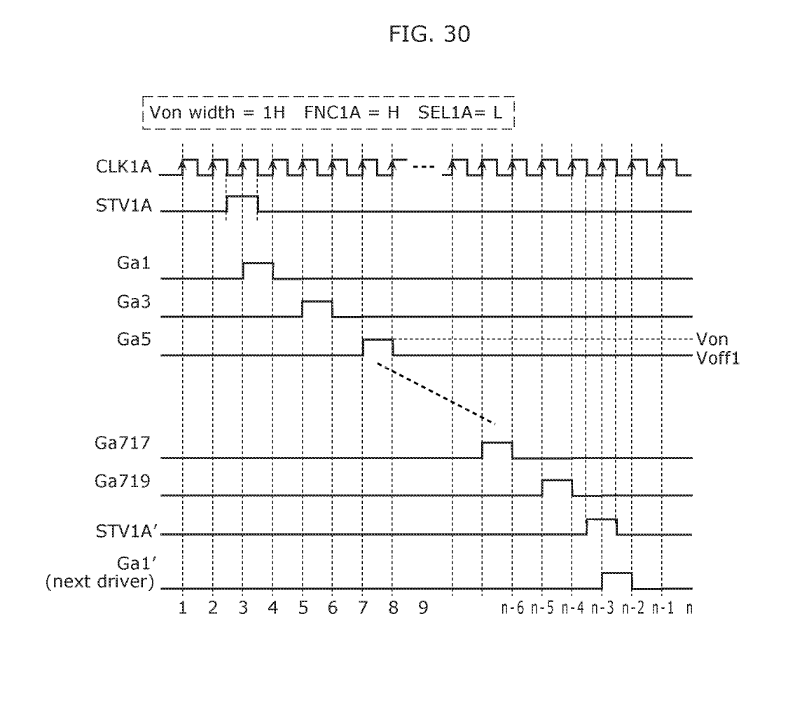

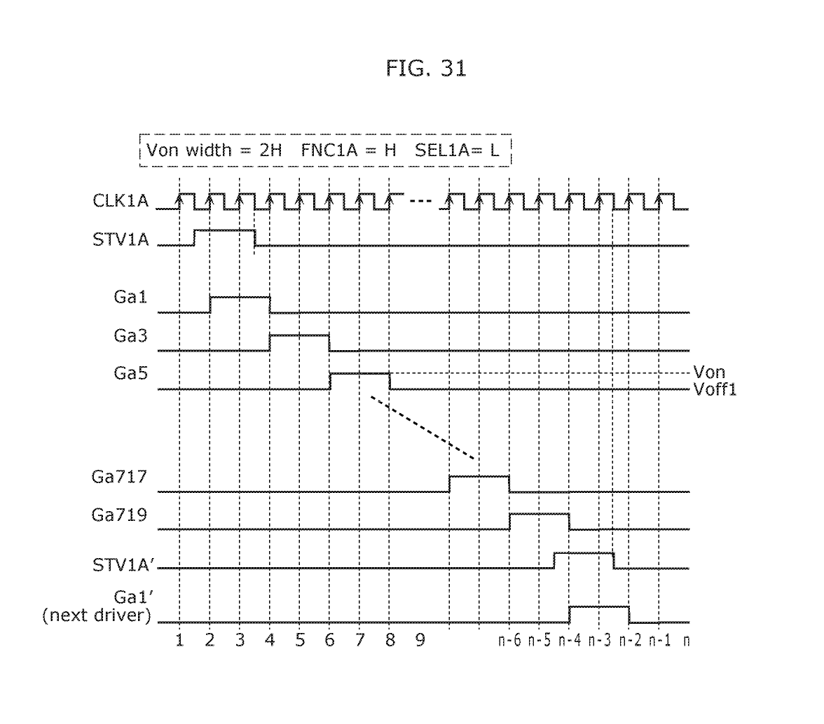

Likewise, FIG. 7, FIG. 8, FIG. 12, FIG. 13, FIG. 14, FIG. 15, FIG. 16, and FIG. 17 are diagrams illustrating timing charts related to the P-channel transistor, FIG. 24, FIG. 25, FIG. 26, FIG. 27, FIG. 28, FIG. 29, FIG. 30, and FIG. 31 are diagrams illustrating timing charts related to the N-channel transistor.

FIG. 7 illustrates the case where the switching transistors are the P-channel transistors, and FIG. 24 illustrates the case where the switching transistors are the N-channel transistors. Accordingly, FIG. 7 corresponds to FIG. 24. Likewise, FIG. 8 corresponds to FIG. 25. FIG. 12 corresponds to FIG. 26, and FIG. 13 corresponds to FIG. 27. FIG. 14 corresponds to FIG. 28, and FIG. 15 corresponds to FIG. 29. FIG. 16 corresponds to FIG. 30, and FIG. 17 corresponds to FIG. 31.

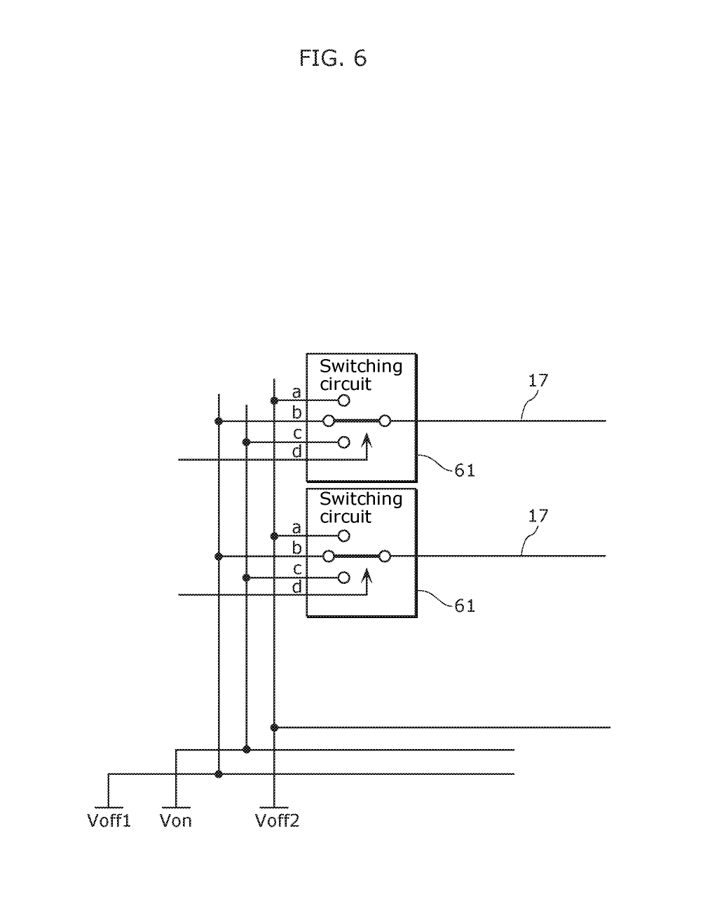

FIG. 6 is a diagram illustrating application of the gate voltage binary driving and the gate voltage ternary driving to the gate signal lines 17. Switching circuits 61 include analog switches. The OFF voltage 1 (Voff1) is applied to terminals b of the switching circuits 61. The OFF voltage 2 (Voff2) is applied to terminals a of the switching circuits 61. The ON voltage (Von) is applied to terminals c of the switching circuits 61.

Terminals d of the switching circuits 61 each are applied with a 2-bit logic signal, thereby selecting one of the terminals a, b, and c, and a selected voltage (Von, Voff1, or Voff2) is applied to the gate signal lines 17.

As illustrated in FIG. 3, the gate driver ICs 12 according to the present disclosure each include two scanning and outputting buffer circuits so as to correspond to the gate signal lines 17 of two types of each of the pixels. The scanning and outputting buffer circuits are two scanning and outputting buffer circuits each including a shift register.

In FIG. 3, the connecting terminals 35 are connecting terminals of the gate driver IC, and the output terminals 34 are output terminals connecting the gate signal lines 17 and the lines of the gate driver IC. In addition, the gate driver IC is a chip on flexible (COF) IC, in other words, a driver IC is mounted on a flexible substrate.

The scanning and outputting buffer circuit 31a drives the gate signal line 17a (GS). The scanning and outputting buffer circuit 31a sets the terminal SEL2A to “H”, and the gate voltage ternary driving is selected. The switching transistor 11b is a transistor which applies a video signal voltage to the pixel 16, and requires a high slew rate because switching between ON and OFF needs to be operated at high speed. In order to implement the high slew rate, the bilateral driving is applied to the gate signal line 17a by the gate driver IC 12a and the gate driver IC 12b.

The scanning and outputting buffer circuit 31b sets the terminal SEL2B to “L”, and the gate voltage binary driving is selected. The switching transistor 11d has a function of interrupting or supplying current to be supplied to the EL element. Interrupting or supplying current to be supplied to the EL element does not require a high-speed operation. For that reason, the gate voltage binary driving is applied to the gate signal line 17b, and ON voltage and OFF voltage 1 are applied. In addition, the gate signal line 17b is driven by the unilateral driving by only the gate driver IC 12a.

FIG. 9 is a diagram explaining the gate driver ICs 12 according to the present disclosure which implement the gate voltage ternary driving. As illustrated in FIG. 9, the scanning and outputting buffer circuits 31 each include two shift register circuits (shift register circuits 91a and 91b).

FIG. 3 illustrates one of the gate driver ICs 12 including two scanning and outputting buffer circuits. FIG. 9 illustrates one of the scanning and outputting buffer circuits 31 included in the gate driver ICs 12.

An STVA signal and an STVB signal [strobe (data) signal] are generated from the STV2A signal. In addition, an FNC signal is generated from the CTL2A signal. The CLK2A signal is inputted as a CLK signal.

The strobe (data) signal is inputted into the shift register circuit 91a through the terminal STVA, and the strobe (data) signal is inputted into the shift register circuit 91b through the terminal STVB. The same clock (CLK) is applied to the shift register circuits 91, and data in the shift register circuits 91 is shifted.

An output a of the shift register circuit 91a and an output b of the shift register circuit 91b are applied to the selecting circuits 92, the selecting circuits 92 perform a logic process and a timing process to turn ON corresponding transistors 93 of the outputting buffer circuit 94. Transistors 93a, 93b, and 93c are controlled so that only one of the transistors is turned ON at a time. The selecting circuits 92 are controlled by the logic of the SEL1 signal.

The Von voltage is applied to the gate signal lines 17 by turning ON the transistors 93a of the outputting buffer circuit 94. The Voff1 voltage is applied to the gate signal lines 17 by turning ON the transistors 93b of the outputting buffer circuit 94. In the same manner as above, the Voff2 voltage is applied to the gate signal lines 17 by turning ON the transistors 93c of the outputting buffer circuit 94.

1-1-3-3. Relation of Connection with the Display Screen

As described above, the gate signal line 17a in the image display apparatus according to the present disclosure is applied with the bilateral driving, and the gate signal line 17b is applied with the unilateral driving.

FIG. 4 is a configuration diagram of the image display apparatus according to the present disclosure, on which the gate driver ICs 12 are mounted. It should be noted that, although the pixels 16 for only one pixel column are illustrated in the display screen 20, the pixels 16 are disposed in a matrix in the display screen 20. In addition, the gate driver IC 12a and the gate driver IC 12b are driver ICs of the same specification. More specifically, the gate driver ICs 12 disposed or mounted on the right side and the left side of the display screen 20 are semiconductor chips of the same specification.

It should be noted that the gate driver ICs 12 are described as semiconductor chips in the Description, the gate driver ICs 12 are not limited to the semiconductor chips. For example, the gate driver ICs 12 may each be formed by directly forming a gate driver circuit on a glass substrate through a low-temperature poly silicon technique.

The gate signal lines 17a are applied with the bilateral driving and the gate signal lines 17b are applied with the unilateral driving. The scanning and outputting buffer circuit 31a of the gate driver IC 12a drives the gate signal lines 17a, and the scanning and outputting buffer circuit 31b of the gate driver IC 12a drives the gate signal lines 17b.

The scanning and outputting buffer circuit 31a drives the gate signal lines 17a corresponding to odd-numbered pixel rows. In FIG. 4, the pixels 16a and 16c correspond to the odd-numbered pixel rows. The scanning and outputting buffer circuit 31b of the gate driver IC 12b drives the gate signal lines 17b corresponding to even-numbered pixel rows. In FIG. 4, the pixel 16b corresponds to the even-numbered pixel row.

The scanning and outputting buffer circuit 31b of the gate driver IC 12a applies the unilateral driving to the gate signal lines 17b. Accordingly, data is inputted to the terminal STV1B of the scanning and outputting buffer circuit 31b, and a position of the data in the shift register circuit is sequentially shifted in synchronization with a clock signal inputted to the terminal CLK1B, thereby making it possible to move a position at which the ON voltage is applied to the gate signal lines 17b. The terminal SEL1B is applied with logic settings to “L”, and the gate voltage binary driving is performed. The terminal CTL1B is set to the level “L”.

According to the Description, the ON voltage is output to a position at which data is present in the shift register circuit, and the OFF voltage is output to a position at which data is not present in the shift register circuit.

The gate signal lines 17a are applied with the bilateral driving by the scanning and outputting buffer circuit 31a of the gate driver IC 12a and the scanning and outputting buffer circuit 31a or the scanning and outputting buffer circuit 31b of the gate driver IC 12b.

The scanning and outputting buffer circuit 31a of the gate driver IC 12b drives the odd-numbered pixel rows, and the scanning and outputting buffer circuit 31b of the gate driver IC 12b drives the even-numbered pixel rows. Accordingly, the gate driver IC 12b operates at a clock frequency of half of a clock frequency of the gate driver IC 12a. In the case of selecting one pixel row at a time, the ON voltage is temporally alternately applied to the gate signal lines 17a of the odd-numbered pixel rows selected by the scanning and outputting buffer circuit 31a of the gate driver IC 12b and the gate signal lines 17a of the even-numbered pixel rows selected by the scanning and outputting buffer circuit 31b of the gate driver IC 12b. The operation speed of the gate driver IC 12b is half of the operation speed of the gate driver IC 12b. The operation clock frequency of the gate driver IC 12a is an integral multiple of the operation clock frequency of the gate driver IC 12b. As described above, the scanning and outputting buffer circuit 31a of the gate driver IC 12b is in charge of driving the gate signal lines 17a of the odd-numbered pixel rows, and the scanning and outputting buffer circuit 31b of the gate driver IC 12b is in charge of driving the signal line 17a of the even-numbered pixel rows. Accordingly, the total number of the gate driver ICs 12b required is half of the total number of the gate driver ICs 12a required.

As illustrated in FIG. 1 and FIG. 4, for example, a plurality of gate signal lines 17 are formed or disposed in a pixel, the gate driver ICs 12a and 12b are connected to the both ends of at least one of the gate signal lines 17, and the gate driver IC 12a is connected to only one end of at least one of the gate signal lines 17 according to an embodiment of the present disclosure. In addition, the image display apparatus according to an embodiment of the present disclosure includes the gate driver ICs 12a and 12b disposed on the left side and the right side of the display screen 20 which are gate driver ICs of substantially the same specification, and the total number of the gate driver ICs 12a disposed on the left side of the display screen 20 and the total number of the gate driver ICs 12b disposed on the right side of the display screen 20 are different. Furthermore, when there is an n-th (n is an integer of at least 2) difference between the clock frequency inputted to the gate driver IC 12a and the clock frequency inputted to the gate driver IC 12b, or the clock frequency inputted to the gate driver IC 12a and the clock frequency inputted to the gate driver IC 12b are substantially the same, the gate driver IC 12b performs n-th (n is an integer of at least 2) operations with respect to the operations performed by the gate driver IC 12a to implement one operation of the gate driver IC 12a (for example, one shift operation of the shift register).

1-2. Driving Method

Next, a driving method of the image display apparatus configured as stated above shall be described.

First, an operation of the scanning and outputting buffer circuits 31 in the case of the gate voltage binary driving and an operation of the scanning and outputting buffer circuits 31 in the case of the gate voltage ternary driving shall be described, focusing on one of the gate signal lines 17 among the plurality of gate signal lines 17 connected to the scanning and outputting buffer circuits 31.

Data is inputted to the terminal STV1B of the scanning and outputting buffer circuit 31b of the gate driver IC 12a, and a position of the data in the shift register circuit is sequentially shifted in synchronization with a clock signal inputted to the terminal CLK1B, thereby making it possible to move a position at which the ON voltage is applied to the gate signal lines 17b. The terminal SEL1B is applied with logic settings to “L”, and the gate voltage binary driving is performed. The terminal CTL1B is set to the level “L”.

FIG. 5 illustrates a timing chart indicating a signal applied to terminals CTL** (CTL2A and CTL2B) and a gate voltage output to the gate signal lines 17a and 17b. More specifically, FIG. 5 illustrates each of the gate voltage binary driving and the gate voltage ternary driving. FIG. 5 illustrates an example in the case where the switching transistor 11 is the P-channel transistor. FIG. 23 illustrates an example in the case where the switching transistor 11 is the N-channel transistor. More specifically, the voltage waveform of a voltage applied to the gate signal lines 17 has a polarity opposite to a polarity of the switch transistor.

A signal to be applied to the terminal CTL** (CTL2A and CTL2B) is a signal which is synchronized with a clock of the terminals CLK** (CLK2A and CLK2B). Data inputted to the terminal STV2A (STV2B) is shifted in the scanning and outputting buffer circuits 31 (31a and 31b) by a clock inputted to the terminal CLK2A (CLK2B).

The timing of applying a voltage to the gate signal lines 17a and the type of the voltage are controlled so that they are the same between the scanning and outputting buffer circuit 31a of the gate driver IC 12a and the scanning and outputting buffer circuit 31a of the gate driver IC 12b. In addition, the timing of applying a voltage to the gate signal lines 17a and the type of the voltage are controlled so that they are the same between the scanning and outputting buffer circuit 31a of the gate driver IC 12a and the scanning and outputting buffer circuit 31b of the gate driver IC 12b.

The gate voltage binary driving and the gate voltage ternary driving are set by the logic signals applied to the terminal SEL** (SEL1A, SEL1B, SEL2A, and SEL2B). In FIG. 4, SEL1A, SEL2A, and SEL2B are set to “H”, and the gate voltage ternary driving is applied to the scanning and outputting buffer circuit 31a of the gate driver IC 12a and the scanning and outputting buffer circuit 31a and 31b of the gate driver IC 12b. In addition, SEL1B of the scanning and outputting buffer circuit 31b of the gate driver IC 12a is set to “L”, and the gate voltage binary driving is set to be performed.

In the case of the gate voltage binary driving, a voltage applied to the gate signal lines 17 changes from Von to Voff1 in synchronization with rising of a signal applied to the terminal CTL** (CTL1A, CTL1B, CTL2A, and CTL2B). The circuit configurations illustrated in FIG. 6 and FIG. 9 are used for explaining the changing of a voltage to be applied.

In the case of the gate voltage ternary driving, a voltage applied to the gate signal lines 17 changes from Von to Voff2 in synchronization with rising of a signal applied to the terminal CTL** (CTL1A, CTL1B, CTL2A, and CTL2B). Subsequently, the Voff2 voltage changes to the Voff1 voltage with rising of a voltage applied to the terminal CLK** (CLK1A, CLK1B, CLK2A, and CLK2B), and the voltage applied to the gate signal lines 17 is kept at Voff1 from this point forward. Here, a period of applying Voff2 is set to a period of 1H (one horizontal scanning period, selecting period for one pixel row) or shorter. A period in which a pulse applied to the terminal CTL** (CTL1A, CTL1B, CTL2A, and CTL2B) is at the level H is equal to or shorter than a period in which a pulse applied to the terminal CLK** (CLK1A, CLK1B, CLK2A, and CLK2B) is at the level H. A signal to be applied to the terminal CTL** (CTL1A, CTL1B, CTL2A, and CTL2B) may be an inversion signal of a signal to be applied to the terminal CLK** (CLK1A, CLK1B, CLK2A, and CLK2B).

The signal to be applied to the terminal CLK** (CLK1A, CLK1B, CLK2A, and CLK2B) and the signal to be applied to the terminal CTL** (CTL1A, CTL1B, CTL2A, and CTL2B) are generated in synchronization with an MCLK signal (clock) or by frequency-dividing the MCLK signal as illustrated in FIG. 7.

Next, an operation of the scanning and outputting buffer circuits 31 which performs the gate voltage binary driving/the gate voltage ternary driving with such timing as described above shall be described, focusing on the plurality of gate signal lines 17 connected to the scanning and outputting buffer circuits 31.

First, an operation of the scanning and outputting buffer circuit 31a of the gate driver IC 12b shall be described.

FIG. 7 illustrates a timing chart of an operation of the scanning and outputting buffer circuits 31a included in the gate driver IC 12b. The terminal SEL2A is set to “H”, and set to the gate voltage ternary driving. The terminal SEL2B of the scanning and outputting buffer circuits 31 is set to “L”, and set to the gate voltage binary driving.

The STV2A signal is a data signal (strobe signal). The STV2A signal is inputted to the scanning and outputting buffer circuit 31a in synchronization with the rising of the CLK2A signal. Gb1 denotes an output waveform of the gate signal line Gb1, Gb3 denotes an output waveform of the gate signal line Gb3, and Gb5 denotes an output waveform of the gate signal line Gb5. Likewise, Gb717 denotes an output waveform of the gate signal line Gb717, and Gb719 denotes an output waveform of the gate signal line Gb719.

The gate driver ICs 12 according to the present disclosure are each assumed to include the output terminals for 720 channels. In addition, according to the present disclosure, necessary gate driver ICs 12 to be matched to the total number of pixel rows of the display screen 20 are mounted or connected.

The gate signal line G1 is applied with the Von voltage in synchronization with the rising of the CLK2A signal, and applied with the Voff2 voltage in synchronization with the rising of the CTL2A signal. Then, the Voff1 voltage is applied in synchronization with a rising signal of the CLK2Ab signal, and the Voff1 voltage is kept until the next gate signal line Gb1 is selected.

In the same manner as above, the gate signal line Gb3 is applied with the Von voltage in synchronization with the rising of the CLK2A signal, and applied with the Voff2 voltage in synchronization with the rising of the CTL2A signal. Then, the Voff1 voltage is applied in synchronization with the rising of the CLK2A, and the Voff1 voltage is kept until the next gate signal line Gb3 is selected.

In addition, the gate signal line Gb5 is applied with the Von voltage in synchronization with the rising of the CLK2A signal, and applied with the Voff2 voltage in synchronization with the rising of the CTL2A signal. Then, the Voff1 voltage is applied in synchronization with the rising of the CLK2A, and the Voff1 voltage is kept until the next gate signal line Gb5 is selected.

In the same manner as above, the gate voltage ternary driving is sequentially applied to the odd-numbered gate signal lines 17 which correspond to the scanning and outputting buffer circuit 31a of the gate driver IC 12b. It should be noted that, when the terminal SEL2A is set to “L”, the gate voltage binary driving is applied and the Von voltage and the Voff1 voltage are applied to each of the odd-numbered gate signal lines instead of the Voff2 voltage.

Next, operations of the scanning and outputting buffer circuit 31a and the scanning and outputting buffer circuit 31b of the gate driver IC 12b shall be described.

FIG. 8 illustrates a timing chart of the scanning and outputting buffer circuits 31a and 31b included in the gate driver IC 12b. The scanning and outputting buffer circuit 31a is in charge of the gate signal lines 17a of the odd-numbered pixel rows, and the scanning and outputting buffer circuit 31b is in charge of the gate signal lines 17a of the even-numbered pixel rows. In other words, the scanning and outputting buffer circuit 31a applies the ON voltage sequentially to the gate signal lines Gb1, Gb3, Gb5, Gb7, . . . , Gb715, Gb717, and Gb719. The scanning and outputting buffer circuit 31b is in charge of the gate signal lines 17a of the even-numbered pixel rows. In other words, the scanning and outputting buffer circuit 31b applies the ON voltage sequentially to the gate signal lines Gb2, Gb4, Gb6, Gb8, . . . , Gb716, Gb718, and Gb720.

It should be noted that, although the period of applying the ON voltage (Von) to the gate signal lines 17 is a period of 1H according to the embodiment described above, the period of applying the ON voltage according to the present invention is not limited to this. The period of applying the ON voltage may be 2H or longer. In addition, a plurality of portions to which the ON voltage is applied may be present in the display screen 20.

The matters described above hold true for the Voff2 voltage. In addition, although the ON voltage is described as one type, the type of the ON voltage is not limited to this. For example, the ON voltage of a plurality of types, such as Von1 and Von2, may be applied to the gate signal lines 17.

The upper portion of the timing chart (CLK2A, STV2A, CTL2A, Gb1, Gb3, Gb5, . . . ) illustrated in FIG. 8 has already been described in FIG. 7, and thus description will be omitted.

The lower portion of the timing chart (CLK2B, STV2B, CTL2B, Gb2, Gb4, Gb6, . . . ) illustrated in FIG. 8 indicates an operation of the scanning and outputting buffer circuit 31b of the gate driver IC 12b.

The gate signal line Gb2 is applied with the Von voltage in synchronization with the rising of the CLK2B signal, and applied with the Voff2 voltage in synchronization with the rising of the CTL2B signal. Then, the Voff1 voltage is applied in synchronization with a rising signal of the CLK2B, and the Voff1 voltage is kept until the next gate signal line G2 is selected.

In the same manner as above, the gate signal line Gb4 is applied with the Von voltage in synchronization with the rising of the CLK2B signal, and applied with the Voff2 voltage in synchronization with the rising of the CTL2B signal. Then, the Voff1 voltage is applied in synchronization with a rising signal of the CLK2B, and the Voff1 voltage is kept until the next gate signal line G4 is selected.

In addition, the gate signal line Gb6 is applied with the Von voltage in synchronization with the rising of the CLK2B signal, and applied with the Voff2 voltage in synchronization with the rising of the CTL2B signal. Then, the Voff1 voltage is applied in synchronization with a rising signal of the CLK2B, and the Voff1 voltage is kept until the next gate signal line G6 is selected.

In the same manner as above, the gate voltage ternary driving is sequentially applied to the even-numbered gate signal lines 17 which correspond to the scanning and outputting buffer circuit 31b of the gate driver IC 12b.

The timing chart in FIG. 8 illustrates that a period of applying the ON voltage to the Gb1 is one cycle of MCLK, which is one horizontal scanning period. A period of applying the ON voltage to the Gb2 is one cycle of MCLK, which is one horizontal scanning period. In addition, the ON voltage positions of Gb1 and Gb2 change in a period of 1H. The same holds true for Gb2, Gb3, . . . .

In addition, the ON voltage positions of Ga1 and Ga2 of the scanning and outputting buffer circuit 31a of the gate driver IC 12a change in a period of 1H. The same holds true for Ga3, Ga4, . . . .

As described above, application of the ON voltage and the OFF voltage to the gate signal line 17a of each of the pixel rows is controlled in synchronization with the gate driver ICs 12a and 12b.

It should be understood that the period of applying the ON voltage (Von) may be 2H or longer. The application is controlled such that the scanning and outputting buffer circuit 31a of the gate driver IC 12a and the scanning and outputting buffer circuits 31a and 31b of the gate driver IC 12b are synchronized, and the same voltage is applied without delay to the gate signal lines 17 selected by the scanning and outputting buffer circuits 31 of both sides.

1-3. Advantageous Effects Etc.

As described above, a feature of the image display apparatus according to the present disclosure is to include a display screen in which pixels each having an EL element are disposed in a matrix, and a sequentially driving circuit such as a gate driver IC.

The image display apparatus according to the present disclosure includes the first gate driver IC and the second gate driver IC. The gate driver ICs each include at least first and second shift register circuits. The first gate signal line and the second gate signal line are formed on the pixels disposed in a matrix in the display screen. The first gate signal line has an end connected to the output terminal of the first gate driver IC and the other end connected to the output terminal of the second gate driver IC, the second gate signal line has an end connected to the output terminal of the first gate driver IC and the other end is opened. The first shift register circuit formed in the first gate driver IC controls the first gate signal line, and the second shift register circuit formed in the first gate driver IC controls the second gate signal line. The first shift register circuit formed in the second gate driver IC controls the first gate signal line located in the first pixel row, and the second shift register circuit formed in the second gate driver IC controls the second gate signal line located in the second pixel row.

The image display apparatus according to the present disclosure includes: the source driver circuit which outputs a video signal to be applied to the pixels; the source signal lines which transmit the video signal output by the source driver circuit; the first gate driver circuit; the second gate driver circuit; and the first gate signal line and the second gate signal line which transmit the selection voltage for selecting a pixel, the first non-selection voltage for placing a pixel in a non-selection state, or the second non-selection voltage for placing a pixel in a non-selection state.

The first gate driver circuit and the second gate driver circuit each select a voltage from among the first non-selection voltage, the second non-selection voltage, and the selection voltage, and output the selected voltage to the first gate signal line and the second gate signal line. The pixels each include: the driving transistor; the first switching transistor; and the second switching transistor. The first gate driver circuit and the second gate driver circuit each include the first scanning circuit and the second scanning circuit. The second gate driver circuit includes the first control terminal for controlling the first scanning circuit and second control terminal for controlling the second scanning circuit.

The operation clock frequency of the first gate driver circuit is an integral multiple of the operation clock frequency of the second gate driver circuit, and the scanning circuits each operate in synchronization with the clock frequency.

The display screen includes the first pixel row and the second pixel row. The first gate signal line of the first pixel row is connected to the first scanning circuit of the first gate driver circuit and the first scanning circuit of the second gate driver circuit. The second gate signal line of the first pixel row is connected to the second scanning circuit of the first gate driver circuit. The first gate signal line of the second pixel row is connected to the first scanning circuit of the first gate driver circuit and the second scanning circuit of the second gate driver circuit. The scanning circuits of the gate driver circuit each output the second non-selection voltage as a result of control of the control terminals at the time of outputting the selection voltage, and outputs the first non-selection voltage in synchronization with the clock frequency after the control of the control terminals.

With the-above described configuration, it is possible to provide an image display apparatus including a gate driver IC which is highly versatile and can be used irrespective of the total number and arrangement of the terminals of the gate signal lines and irrespective of the specification or the like of the image display apparatus. In addition, it is possible to dispose the gate driver IC or configure the panel module so as to correspond to a slew rate required by each of the gate signal lines.

It should be noted that the gate driver ICs 12a and 12b correspond to the first gate driver circuit and the second gate driver circuit, respectively. In addition, the scanning and outputting buffer circuits 31a and 31b correspond to the first scanning circuit and the second scanning circuit, respectively. The switching transistors 11b and 11d correspond to the first switching transistor and the second switching transistor, respectively. The gate signal lines 17a and 17b correspond to the first gate signal line and the second gate signal line, respectively. The terminal CTL** (CTL1A and CTL2A) of the scanning and outputting buffer circuit 31a corresponds to the first control terminal, and the terminal CTL** (CTL1B and CTL2B) of the scanning and outputting buffer circuit 31b corresponds to the second control terminal.

### Modification Example of Embodiment 1

Next, a modification example of Embodiment 1 shall be described.

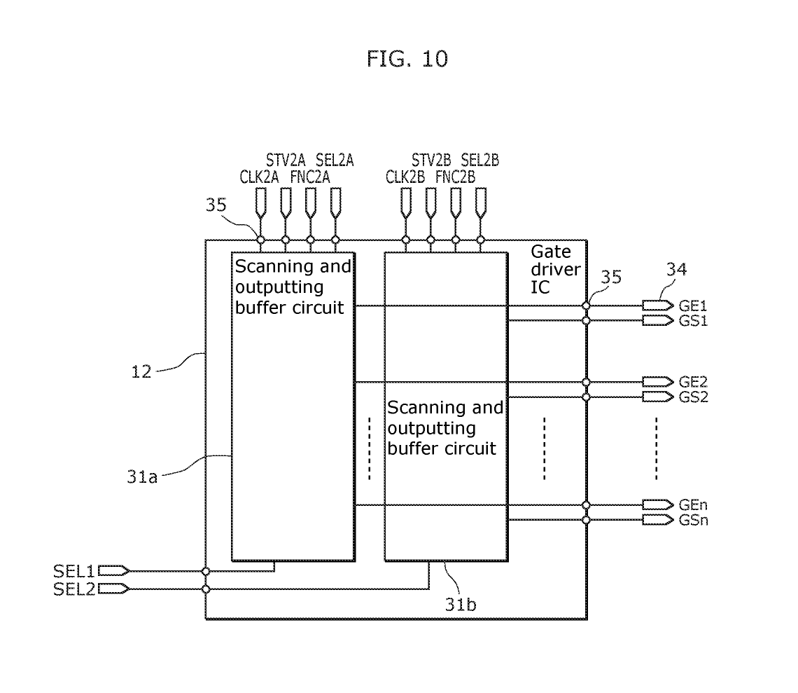

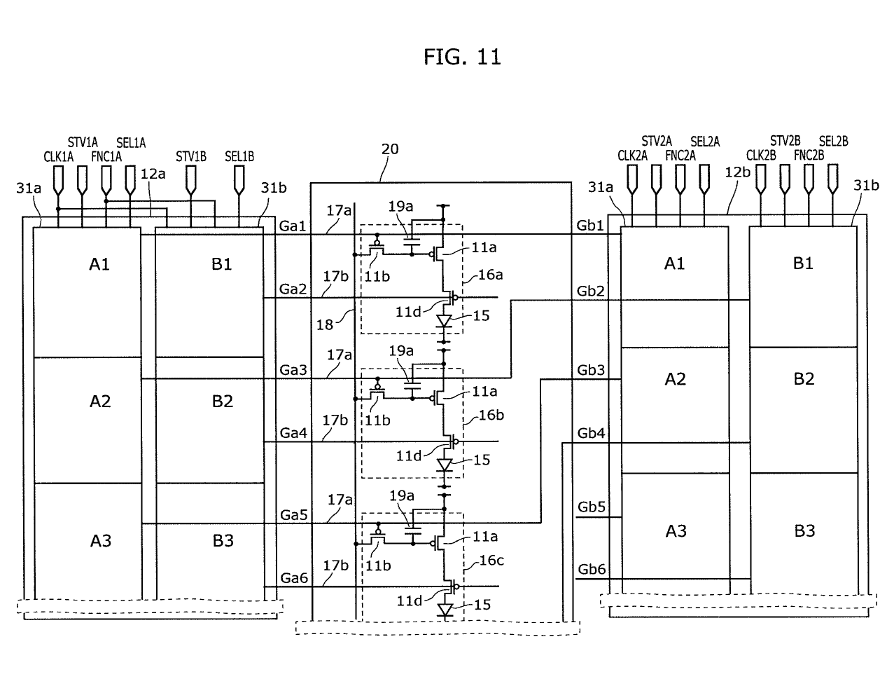

FIG. 10 is a block diagram illustrating a configuration of a gate driver IC 12 according to a modification example of Embodiment 1 of the present disclosure. The gate driver IC 12 illustrated in FIG. 10 differs from the gate driver IC 12 illustrated in FIG. 3 in that the gate driver IC 12 illustrated in FIG. 10 includes input terminals FNC** (FNC2A and FNC2B) in place of the terminals CTL** (CTL2A and CTL2B). The same holds true for FIG. 4 and FIG. 11. FIG. 11 is a configuration diagram of the image display apparatus of the present disclosure, on which the gate driver ICs 12 according to the modification example of Embodiment 1 is mounted.

It should be noted that, although a period from a rising edge of an arbitrary CLK** to a rising edge of the next clock is exemplified as one clock cycle of the clock CLK**, the one clock cycle is not limited to this. For example, the one clock cycle may be a period from a falling edge of an arbitrary CLK** to a falling edge of the next clock. In addition, when a shifting operation is performed or a change occurs at both the rising and falling of CLK**, rising and falling of CLK** correspond to a two clock cycle, and rising or falling of CLK** corresponds to the one clock cycle. Furthermore, when a shifting operation is performed or a change occurs not at a falling edge of CLK** or a falling of a clock but with a voltage level of a clock, a clock cycle is determined based on a predetermined level.

In addition, the gate driver circuits according to an embodiment of the present disclosure, when the gate driver ICs 12a and 12b are of the same specification, and clock signals inputted have the same frequency, can be formed or set such that the shift register or the like of the gate driver IC 12a performs one shifting operation in one clock cycle (one operation), whereas the shift register or the like of the gate driver IC 12b performs one shifting operation in n (n is an integer of at least 2) clock cycle (n operation). The matters described above are applicable as appropriate to the examples of the disclosure according to the present invention. For example, the matters described above are also applicable to the examples of the disclosure illustrated in, for example, FIG. 4, FIG. 5, FIG. 7, FIG. 8, etc. It also should be understood that the matters described above are also applicable to the examples of the disclosure illustrated in FIG. 10, FIG. 11, FIG. 12 to FIG. 17, etc.

The terminals FNC** (FNC2A and FNC2B) are logic terminals which perform control of data input (STVA and STVB) to the shift register circuits 91 illustrated in FIG. 9, control of clock control (CLK), and (ii) control of the selecting circuit 92. As illustrated in FIG. 7, rising of CLK2A and rising of CTL2A are controlled by controlling the shift registers.

It should be noted that, although it is described that “one operation” is performed with rising of CLK** according to an embodiment of the present disclosure, “one operation” is not limited to this, and one operation” may be performed with falling of UK**. Furthermore, “one operation” may be performed with each of rising and falling of CLK**. In addition, “one operation” may be performed according to a potential level. It should be understood that the matters described above are not limited to CLK** but applied to other control signals as appropriate.

Although not illustrated in the shift register circuits in FIG. 9, a dividing circuit of the clock CLK, a control circuit for a shifting position of a data position in the shift register circuit 91, and the like are included in the shift register circuit 91. More specifically, the shifting state of FIG. 12 and the shifting state of FIG. 15 are switched according to the logic signal applied to the terminal FNC.

The shifting state of a scanning and outputting buffer circuit 31 (or the gate driver ICs 12) in FIG. 12 is referred to as the second mode, and the shifting state of a scanning and outputting buffer circuit 31 (or the gate driver ICs 12) in FIG. 15 is referred to as the first mode. In FIG. 15, a data position in the scanning and outputting buffer circuit 31 is shifted in synchronization with one clock cycle. In FIG. 12, compared to FIG. 15, a data position in the scanning and outputting buffer circuit 31 is shifted in synchronization with n clock cycles (two clock cycles in the example of the disclosure). The same clock is inputted to the clock terminals (CLK**) of the gate driver IC 12a and the gate driver IC 12b. In the image display apparatus in FIG. 11 according to an embodiment of the present disclosure, the terminal FNC1A of the gate driver IC 12a is set to “L”, and the gate driver IC 12a operates in the first mode. Accordingly, in the gate driver IC 12a, the data position in the shift register 31 is shifted with the one clock cycle. The terminal FNC1A of the gate driver circuit 12b is set to “H”, and the gate driver IC 12b operated in the second mode. Accordingly, in the gate driver circuit 12a, the data position in the shift register 31 is shifted with the two clock cycle.

When the logic of the voltage applied to the terminal FNC is set to “H”, the position at which the ON voltage (Von) is applied to each of the gate signal lines is shifted with two clocks (shifted with two clock cycle) as illustrated in FIG. 12. In other words, the shifting operation of the gate driver circuit 12a is twice as much as the shifting operation of the gate driver IC 12b. Or, the total number of clock inputs required for the shifting operation of the gate driver IC 12b is twice as many as the total number of clock inputs required for the shifting operation of the gate driver IC 12a. Accordingly, for the gate signal lines to which the ON voltage is applied, the ON voltage is applied, for every two clocks, to the gate signal lines Gb1, Gb3, Gb5, . . . . In contrast, when the logic of the voltage applied to the terminal FNC is set to “L”, the position at which the ON voltage (Von) is applied to each of the gate signal lines is shifted with one clock as illustrated in FIG. 15. Accordingly, the gate signal lines to which the ON voltage is applied are the gate signal lines Gb1, Gb3, Gb5, The terminal FNC** (FNC1A and FNC2A) of the scanning and outputting buffer circuit 31a corresponds to the first control terminal, and the terminal FNC** (FNC1B and FNC2B) of the scanning and outputting buffer circuit 31b corresponds to the second control terminal.

As described above, when the logic of the voltage applied to the terminal FNC is set to “L”, each pixel row is sequentially selected with one clock (cycle) as in a normal operation. When the logic of the voltage applied to the terminal FNC is set to “H”, each pixel row is selected with two clocks (cycle).

It should be noted that, in the example of FIG. 11, the shift register 31a of the gate driver circuit 12b is in charge of the odd-numbered pixel rows, and the shift register 31b of the gate driver circuit 12b is in charge of the even-numbered pixel rows, according to the example of the present disclosure. According to the example of FIG. 11, it is possible to configure the image display apparatus with a total number of the gate driver ICs 12b disposed on the right side of the display screen 20 being half of the total number of the gate driver circuits 12a disposed on the left side of the display screen 20, as illustrated in FIG. 1. The total number of clocks (clock cycles) required for one shifting operation of the shift register 31 in the gate driver IC 12b is twice as many as the total number of clocks of the shift register 31 in the gate driver IC 12a.

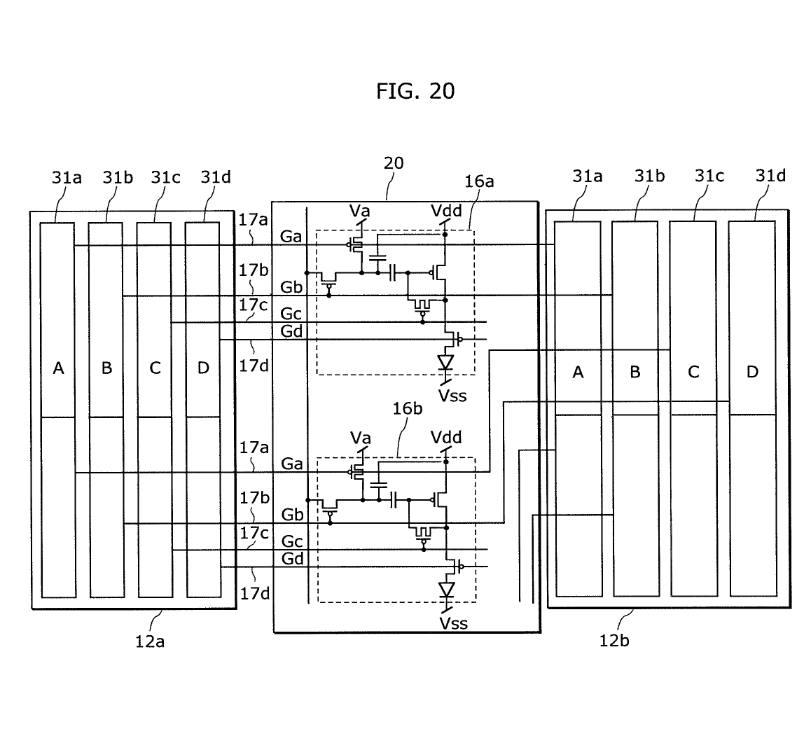

In addition, as an example of the present discloser, in the case where: the gate driver IC 12b includes three shift registers 31 (31a, 31b, and 31c); the scanning and outputting buffer circuit 31a is in charge of the (3m−2)th pixel rows (m is an integer of at least 1); the scanning and outputting buffer circuit 31b is in charge of the (3m−1)th pixel rows (m is an integer of at least 1), and the scanning and outputting buffer circuit 31c is in charge of 3m-th pixel rows (m is an integer of at least 1); the total number of the clocks (clock cycles) required for the shifting operation of the shift register 31 of the gate driver IC 12b is three times as many as the total number of the clocks required for the shifting operation of the shift register 31 of the gate driver IC 12a. In this case, it is possible to configure the image display apparatus with a total number of the gate driver IC 12b disposed on the right side of the display screen 20 being one third of the total number of the gate driver circuits 12a disposed on the left side of the display screen 20. It should be understood that the matters described above are also applicable to other examples of the disclosure according to the present invention, such as FIG. 2, FIG. 4, FIG. 20 to FIG. 22, etc.

It should be understood that the logic of the voltage applied to the terminal FNC may be reversed between “H” and “L”. In addition, although each pixel row is selected with two clocks (cycles) when the terminal FNC is set to H, the clocks (cycles) are not limited to two clocks (cycles), and each pixel row may be selected with three clocks (cycle) or four clocks (cycle), for example.

With the clock inputted to the terminal clock (CLK**), data in the scanning and outputting buffer circuit 31 of the gate driver IC 12 is shifted. The total number of clock inputs for implementing the shifting operation of the scanning and outputting buffer circuit 31 of the gate driver IC 12b is n times as many as the total number of clock inputs (3 is an integer of at least 2) of the gate driver IC 12a. The matters described above are applicable as appropriate to the examples of the disclosure of the present invention. For example, the matters described above are also applicable to the examples of the disclosure such as FIG. 4, FIG. 5, FIG. 7, and FIG. 8. In addition, the matters described above are also applicable to the examples of the disclosure such as FIG. 10, FIG. 11, FIG. 12 to FIG. 17, etc.

When the logic signal to the terminal FNC**? is set to “H”, the shifting operation illustrated in FIG. 12 (second mode) is performed. This is an operation of the gate driver IC 12b. When the logic signal to the terminal FNC is set to “L”, the shifting operation illustrated in FIG. 15 (first mode) is performed. This is an operation of the gate driver IC 12a. The terminal FNC** is a terminal connected to a setting circuit for setting the operation mode (the first mode or the second mode). According to the logic setting to the terminal FNC**, the setting circuit selects between the first mode and the second mode to set the operation of the scanning and outputting buffer circuit 31.

It should be noted that, although the first mode or the second mode is set according to the logic setting to the terminal FNC**, the setting is not limited to this. For example, the first mode or the second mode may be set by command setting to the setting circuit. For example, it is exemplified that DATA is inputted via a command transmitting line to the gate driver IC 12 as a command from outside, and the input DATA is converted to a setting command in command decoder circuits 351 to set an operation or a function, as illustrated in FIG. 35. The command decoder circuits 351 serve as the setting circuits for setting the first mode or the second mode.

FIG. 12 illustrates a timing chart of the scanning and outputting buffer circuit 31a included in the gate driver IC 12b illustrated in FIG. 11. The logic of the voltage applied to the terminal FNC2A is set to “H”. The period of time of applying the Von voltage is 1H (selecting period for one pixel row). The terminal SEL2A is set to “H”, and applied with the gate voltage ternary driving. It should be noted that switching or setting of the gate voltage binary driving and the gate voltage ternary driving may be performed using a hard terminal as with the terminal FNC**, or may be set via a command transmitting signal DATA as illustrated in FIG. 35. The same holds true for other terminals (STV**, CLK**, SEL**, etc.) or settings.

The scanning and outputting buffer circuit 31a is controlled by the clock input to the terminal CLK2A and a data (strobe) signal to the terminal STV2A. The voltages (Von, Voff1, and Voff2) to be applied to the gate signal lines Gb1, Gb3, . . . , Gb717, and Gb719 and the timing thereof are the same as those illustrated in FIG. 7.

FIG. 13 illustrates a timing chart of the scanning and outputting buffer circuit 31b included in the gate driver IC 12b illustrated in FIG. 11. The logic of the voltage applied to the terminal FNC2B is set to “H”. The period of time of applying the Von voltage is 1H (selecting period for one pixel row). The terminal SEL2B is set to “H”, and applied with the gate voltage ternary driving.

The scanning and outputting buffer circuit 31b is controlled by the dock input to the terminal CLK2B, and a data (strobe) signal to the terminal STV2B. The voltages (Von, Voff1, and Voff2) to be applied to the gate signal lines Gb2, Gb4, . . . , Gb718, and Gb720 and the timing thereof are the same as those illustrated in the lower portion of FIG. 8.

FIG. 14 illustrates an example of the embodiment in which the application period of Von in FIG. 12 is set to 2H. Since other configurations and operations are the same as those illustrated in FIG. 12, descriptions for them shall be omitted. The application period of Von is set to 2H, and thus the ON voltage is applied to the gate signal lines 17 consecutively for the period of 2H (the selecting period for two pixel rows). Accordingly, it is possible to apply the ON voltage sufficiently to the selected gate signal lines, and the transistors 11 connected to each of the gate signal lines can be sufficiently turned ON. For example, the ON voltage is applied to the switching transistor 11b illustrated in FIG. 11 for the period of 2H, thereby making it possible to successfully apply a video signal from the source driver IC 14 to each of the pixels 16. Although the period of Von is set to 2H in the above-described embodiment, the period of Von is not limited to this, and it should be understood that the period of Von may be a plurality of periods H which is at least three H.

It should be noted that, even when the period of Von is set to a plurality of periods H, the period in which the Voff2 voltage is applied is set to a period of 1H (when the terminal SEL is set to H).

FIG. 15 illustrates a timing chart of the scanning and outputting buffer circuit 31a included in the gate driver IC 12a illustrated in FIG. 11. The logic of the voltage applied to the terminal FNC1A is set to “L”. In other words, a selected position is shifted for each of the pixel rows Ga1, Ga3, and Ga5. The period of time of applying the Von voltage is 1H (selecting period for one pixel row). In addition, the terminal SEL1A is set to “H”, and applied with the gate voltage ternary driving. The scanning and outputting buffer circuit 31a is controlled by the clock input to the terminal CLK1A, and a data (strobe) signal to the terminal STV1A. Von, Voff1, and Voff2 are sequentially applied to the gate signal lines Ga1, Ga3, . . . , Ga717, and Ga719.

The operation of the timing chart illustrated in FIG. 15 is performed to the scanning and outputting buffer circuit 31a of the gate driver IC 12a, the operation of the timing chart illustrated in FIG. 12 is performed to the scanning and outputting buffer circuit 31a of the gate driver IC 12b, and the operation of the timing chart illustrated in FIG. 13 is performed to the scanning and outputting buffer circuit 31b of the gate driver IC 12b, thereby implementing the bilateral driving to the gate signal line 17a of each of the pixels.

In addition, the scanning and outputting buffer circuit 31b of the gate driver IC 12a implements the operation of the timing chart illustrated in FIG. 15 with the terminal SEL1B being set to “L” and the gate voltage binary driving being applied (the Voff2 period in FIG. 15 is changed to the Voff1 period. STV1A, Ga1, Ga3, Ga5, . . . , Ga717, and Ga719 are replaced with STV1B, Ga2, Ga4, Ga6, . . . , Ga718, and Ga720, respectively).

It is possible to implement the driving system illustrated in FIG. 16 by setting FNC1A to “H” and SEL1A to “L” for the scanning and outputting buffer circuit 31a of the gate driver IC 12a. It is possible to implement the driving system illustrated in FIG. 17 by setting data to be inputted to the terminal STV1A to have a width of 2H, setting FNC1A to “H”, and setting SEL1A to “L” for the scanning and outputting buffer circuit 31a of the gate driver IC 12a.

### Embodiment 2

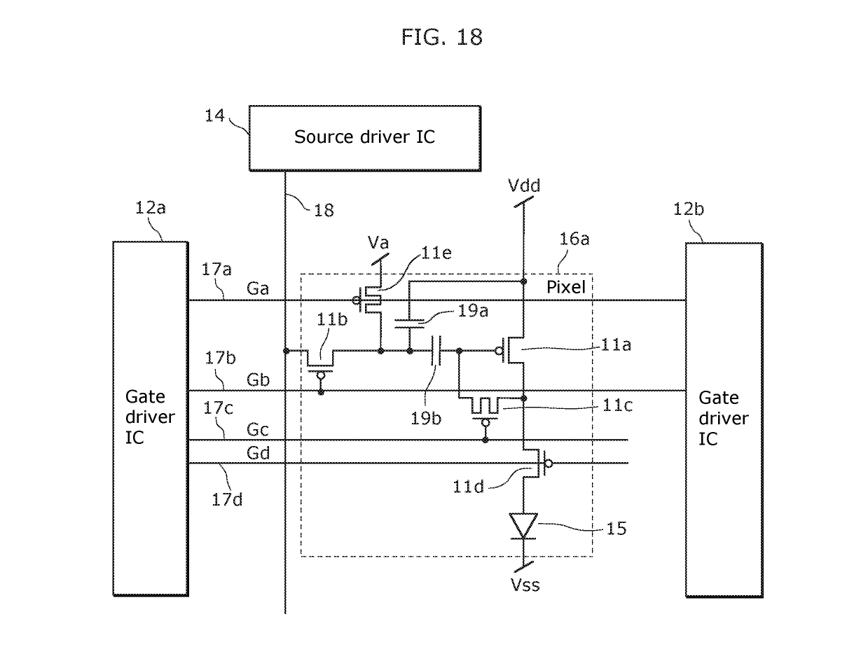

According to Embodiment 1 and the modification examples described above, the total number of the gate signal lines 17 included in each of the pixels is two (two types). In contrast, an image display apparatus according to the present embodiment is different from the image display apparatus of Embodiment 1 and the modification examples in that the image display apparatus according to the present embodiment includes four gate signal lines (four types of gate signal lines) for each of the pixels. In the pixel circuit illustrated in FIG. 2, a video signal from the source signal line 18 turns ON the switching transistor 11b, and is galvanically applied to the gate terminal of the driving transistor 11a. In the pixel circuit illustrated in FIG. 18, a video signal from the source signal line 18 turns ON the switching transistor 11b, and is alternatingly applied to the gate terminal of the driving transistor 11a via the capacitor 19b.

In addition, in the pixel circuit illustrated in FIG. 18, an offset cancelling driving which chancels characteristic variations of the driving transistor 11a is implemented by operating the switching transistors 11c, 11e, and 11d, thereby realizing excellent visual quality without display unevenness. Hereinafter, Embodiment 2 shall be described with reference to the Drawings.

2-1. Configuration

2-1-1. Pixel

FIG. 18 is a diagram illustrating a pixel configuration of an image display apparatus according to the present embodiment, in which four gate signal lines 17 (four types of gate signal lines) are included in each of the pixels. It should be noted that there are instances where the gate signal lines 17a, 17b, 17c, and 17d are not specifically distinguished from each other and described as gate signal lines 17 as above.

The gate signal line 17a (Ga) is connected to the gate terminal of the switching transistor 11e, and controls ON and OFF of the switching transistor 11e. The gate signal line 17b (Gb) is connected to the gate terminal of the switching transistor 11b, and controls ON and OFF of the switching transistor 11b. The gate signal line 17c (Gc) is connected to the gate terminal of the switching transistor 11c, and controls ON and OFF of the switching transistor 11c. The gate signal line 17a (Gd) is connected to the gate terminal of the switching transistor 11d, and controls ON and OFF of the switching transistor 11d. The state of interconnection of each of the transistors 11 and the capacitor 19 is illustrated in the equivalent circuit diagram of FIG. 18, and thus description will be omitted.

With the pixel configuration illustrated in FIG. 18, gate driver ICs 12a and 12b are connected to the gate signal lines 17a and 17b, and the bilateral driving is performed. Only the gate driver IC 12a is connected to the gate signal lines 17c and 17d, and the unilateral driving is performed.

In FIG. 18, the source terminal of the switching transistor 11d is connected to the drain terminal of the driving transistor 11a that is the P-channel transistor, and the anode terminal of the EL element 15 is connected to the drain terminal of the switching transistor 11d. In addition, a cathode voltage Vss is applied to the cathode terminal of the EL element 15. An anode voltage Vdd is applied to the source terminal of the driving transistor 11a.

When an ON voltage is applied to the gate signal line 17d, the switching transistor 11d is turned ON, and a light-emission current is supplied to the EL element 15 from the driving transistor 11a. The EL element 15 emits light according to the magnitude of the light-emission current/

The source terminal and the drain terminal of the switching transistor 11c are connected between the gate terminal and the drain terminal of the driving transistor 11a. An ON voltage is applied to the gate signal line 17c, thereby short-circuiting (connecting) the driving transistor 11a between the gate terminal and the drain terminal.

One of the terminals of the capacitor 19b is connected to the gate terminal of the driving transistor 11a, and the other terminal of the capacitor 19b is connected to the drain terminal of the switching transistor 11b. The source terminal of the switching transistor 11b is connected to the source signal line 18. When an ON voltage is applied to the gate signal line 17b, the switching transistor 11b is turned ON, and a video signal (voltage or current) Vs applied to the source signal line 18 is applied to the pixel 16. It should be noted that, although the video signal is a video signal voltage in the present disclosure, the video signal may be a video signal current.

One of the terminals of the capacitor 19a is connected to the drain terminal of the transistor 11b, and the other terminal is connected to the anode electrode so as to be applied with an anode voltage Vdd.

It should be noted that, although the other terminal of the capacitor 19a is connected to the anode electrode so as to be applied with the anode voltage Vdd, the present disclosure is not limited to this. For example, the other terminal of the capacitor 19a may be connected to any other DC voltage.

Although the source terminal of the transistor 11d is connected to the anode electrode so as to be applied with the anode voltage Vdd, connection of the source terminal of the transistor 11d is not limited to this. For example, the other terminal of the capacitor 19a may be connected to any other DC voltage. In other words, the other terminal of the capacitor 19a and the source terminal of the transistor 11a may be connected to terminals of different potential.

For example, a configuration in which the source terminal of the transistor 11a is connected to an electrode or a line to which the anode voltage Vdd is applied, and one of the terminals of the capacitor 19a is connected to an electrode or a line to which a voltage of DC voltage Vb=5 (V) is applied.

The drain terminal of the transistor 11e is connected to the drain terminal of the transistor 11b, and the source terminal of the transistor 11e is connected to an electrode or a signal line to which a reset voltage Va is applied. The transistor 11e is turned ON and the reset voltage Va is applied to the capacitor 19a, by applying the ON voltage to the gate signal line 17a.

The transistor 11c and the transistor 11e are each the P-channel transistor, and have a lightly doped drain (LDD) structure. In addition, the transistors 11c and 11e each have at least a double-gate (dual gate) structure. The transistors 11c and 11e each preferably have at least a triple-gate structure. More specifically, a structure in which gates of a plurality of transistors are connected in series. It is possible to place the off-characteristics of the transistors 11c and 11e in a good condition, by employing the LDD structure or a multi-gate (dual gate, triple-gate, or more gates) structure. When the off-characteristics of the transistor 11c and the transistor 11e are not in a good condition, a charge of the capacitor 19 cannot be held in a good condition.

It is preferable that transistors other than the transistors 11c and 11e are each the P-channel transistor and have the LDD structure. In addition, the transistors have the multi-gate structure as necessary.

The multi-gate (at least the dual gate) transistors are employed, and the LDD structure is combined, thereby making it possible to suppress the off-leakage and implement excellent contrast and offset cancelling operation In addition, excellent high-luminance display and image display can be implemented.

2-1-2. Gate Driver IC

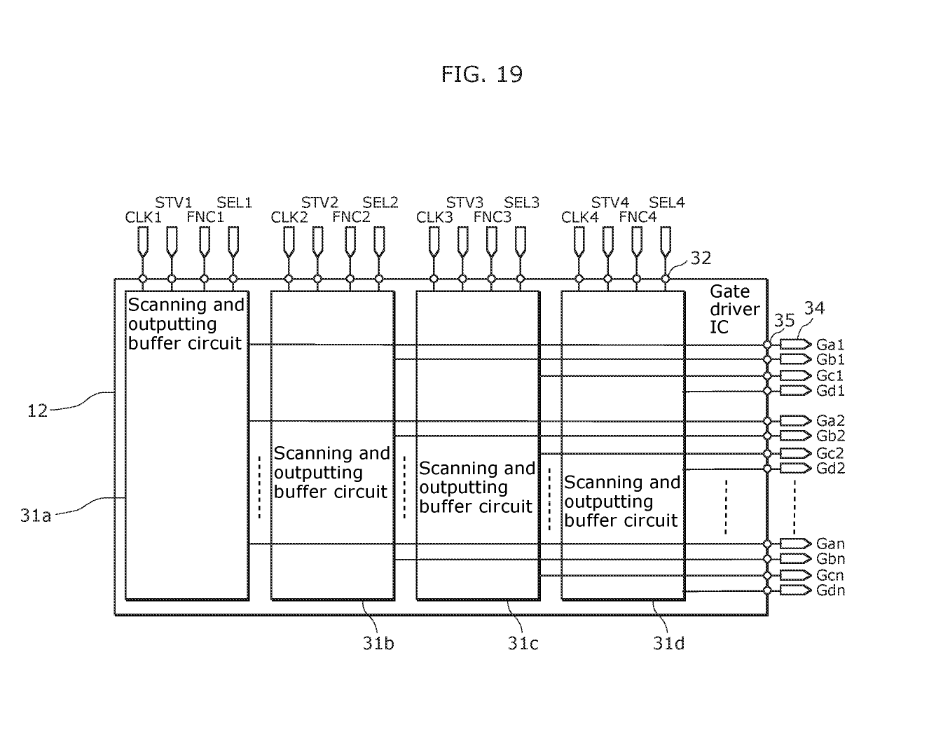

FIG. 19 is a block diagram of the gate driver IC 12 according to the present disclosure, which corresponds to the case where there are four types of the gate signal line 17 (i.e., the total number of the gate signal lines 17 to be independently controlled) of a pixel as illustrated in FIG. 18.

Four scanning and outputting buffer circuits 31 (31a, 31b, 31c, and 31d) are formed or disposed in the gate driver IC 12. The scanning and outputting buffer circuit 31a drives the gate signal line 17a, and the scanning and outputting buffer circuit 31b drives the gate signal line 17b. The scanning and outputting buffer circuit 31c drives the gate signal line 17c, and the scanning and outputting buffer circuit 31d drives the gate signal line 17d . . . . Since other configurations are the same as those of other embodiments, description shall be omitted.

Next, a relation of connection between the gate driver IC 12 having a configuration described above and the display screen 20 shall be described.

FIG. 20 is a schematic diagram of the image display apparatus according to the present disclosure, that is, a configuration diagram of an image display apparatus according to Embodiment 2, on which the gate driver IC 12 is mounted. The scanning and outputting buffer circuits 31 (31a, 31b, 31c, and 31d) of the gate driver IC 12a each control a different one of the gate signal lines 17 (17a, 17b, 17c, and 17d), and applies an ON voltage and an OFF voltage to the gate signal lines 17. The scanning and outputting buffer circuits 31a and 31b of the gate driver IC 12b each control the gate signal lines 17 (17a and 17b) of the odd-numbered pixel rows, and applies an ON voltage and an OFF voltage to the gate signal lines 17. The scanning and outputting buffer circuits 31c and 31d of the gate driver IC 12b each control the gate signal lines 17 (17c and 17d) of the even-numbered pixel rows, and applies an ON voltage and an OFF voltage to the gate signal lines 17.

The gate signal line 17a and the gate signal line 17b are driven by the gate driver ICs 12a and 12b. In other words, the bilateral driving is applied to the gate signal lines 17a and 17b. The switching transistor 11e implements the function of applying a Va voltage to the gate terminal of the driving transistor 11a, and the switching transistor 11b implements the function of supplying a video signal voltage to the driving transistor 11a, and thus a high-speed ON and OFF operation is required. The bilateral driving is applied to the gate signal lines 17a and 17b, thereby making it possible to operate the switching transistors 11b and 11e at an excellent slew rate. On the other hand, the switching transistors 11c and 11d do not require a high-speed operation. Accordingly, it is possible to implement a sufficiently function with the unilateral driving using only the gate driver IC 12a.

In the example illustrated in FIG. 20, the gate driver IC 12a is in charge of the gate signal lines 17 (17a, 17b, 17c, and 17d) of all of the pixel rows. The shift register and outputting circuits 31a and 31b of the gate driver IC 12b are in charge of the gate signal lines 17a and 17b of the odd-numbered pixel rows, and the shift register and outputting circuits 31c and 31d of the gate driver IC 12b are in charge of the gate signal lines 17a and 17b of the even-numbered pixel rows. Also in the configuration illustrated in FIG. 20, the total number of the gate driver ICs 12b used may be half of the total number of the gate driver ICs 12a used as with the cases illustrated in FIG. 1 and FIG. 11. Accordingly, it is possible to reduce the total number of gate driver ICs 12 used, and provide a low-cost image display apparatus.

Control and functions of the terminal FNC, the terminal CLK, the terminal SEL, and the terminal STV are described in the other embodiment, and thus description shall be omitted. In addition, the timing chart is also described in the other embodiment, and thus description shall be omitted.

2-2. Advantageous Effects Etc.

As described above, the image display apparatus according to the present embodiment is different from the image display apparatus according to Embodiment 1 and the modification example thereof in that the image display apparatus according to the present embodiment includes four gate signal lines (four types) for each of the pixels 16. More specifically, among the four gate signal lines 17a, 17b, 17c, and 17d, the bilateral driving is applied to the two gate signal lines 17a and 17b and the unilateral driving is applied to the two gate signal lines 17a and 17b. The image display apparatus described above also produces the same advantageous effects as those of Embodiment 1 and the modification example thereof. More specifically, it is possible to use gate driver ICs 12a and 12b which are highly versatile and can be used irrespective of the total number and arrangement of the gate signal lines 17 and irrespective of the specification or the like of the image display apparatus. In addition, it is possible to reduce the total number of the gate driver ICs 12b used by a half of the total number of the gate driver ICs 12a used, making it possible to lower the costs.

It should be noted that, although the bilateral driving is applied to the gate signal lines 17a and 17b and the unilateral driving is applied to the gate signal lines 17c and 17d in the above description, the total number of the gate signal lines to which the bilateral driving is applied and the total number of the gate signal lines to which the unilateral driving is applied are not limited to those described above.

For example, although FIG. 18 illustrates the configuration of four gate signal lines per pixel, the case where the bilateral driving is applied to the gate signal line 17a and the unilateral driving is applied to the other gate signal lines 17 (17b, 17c, and 17d) is also conceivable. In this case, one fourth of the total number of gate driver ICs 12a used is sufficient for the total number of the gate driver ICs 12b used. Accordingly, it is possible to reduce the total number of gate driver ICs 12 used, and provide a low-cost image display apparatus.

### Modification Example of Embodiment 2

### 3-1. Configuration

3-1-1. Pixel

For example, FIG. 21 illustrates a pixel configuration. FIG. 21 is a circuit diagram illustrating a pixel circuit according to a modification of Embodiment 2. In FIG. 21, the gate driver ICs 12a and 12b apply the bilateral driving to the gate signal lines 17a and 17b. The gate driver IC 12a applies the unilateral driving to the gate signal lines 17c and 17d.

The source driver IC 14 is a driving circuit which is connected to the source signal line 18 and has a function of outputting a video signal voltage corresponding to a display image to the EL element 15.

The control circuit of which illustration is omitted is a control circuit which has a function of controlling the gate driver ICs 12 and the source driver IC 14. The control circuit includes a memory (not illustrated) on which correction data, etc. of each of the EL elements 15 is recorded, which reads the correction data, etc. written on the memory, corrects a video signal inputted from outside based on the correction data, and outputs the corrected video signal to the source driver IC 14.

In addition, although it is not illustrated in FIG. 21, the anode voltage Vdd, the cathode voltage Vss, and the reference voltage (Vref and Vini) are each commonly supplied to all of the pixels 16, and connected to a voltage generating circuit (not illustrated). Furthermore, when a voltage resulting from adding a luminescence production starting voltage of the EL element 15 to the threshold voltage of the driving transistor 11a is greater than 0 V, the voltage Vini may be substantially the same voltage as the cathode voltage Vss. With this, the types of an output voltage of the voltage generating circuit (not illustrated) is reduced and the circuit are more simplified.

The gate terminal of the switching transistor 11e is connected to the gate signal line 17c, and one of the source and the drain is supplied with Vref. The switching transistor 11c has a function of determining a timing of applying Vini to an electrode of the capacitor 19c. The switching transistor 11e and the switching transistor 11c are each formed of, for example, an n-type thin film transistor (n-type TFT).

The capacitor 19a is a capacitor having the first electrode connected to the gate terminal of the driving transistor 11a and the second electrode connected to the source terminal of the driving transistor 11a.

The capacitor 19a has a function of holding a voltage corresponding to the signal voltage supplied from the source signal line 18, stably holding a potential between the gate electrode and the source electrode of the driving transistor 11a after the switching transistor 11b is turned OFF, for example, and stabilizing current supplied to the EL element 15 from the driving transistor 11a.

The driving transistor 11a is a driving element including a drain connected via the switching transistor 11d to the first power line and supplied with an anode voltage Vdd, and a source connected to an anode of the EL element 15. The driving transistor 11a converts a voltage corresponding to a signal voltage applied between the gate and source into a drain current corresponding to the signal voltage. Then, the driving transistor 11a supplies this drain current as a signal current to the EL element 15. The driving transistor 11a is formed of, for example, an n-type thin film transistor (n-type TFT).

The EL element 15 is a light-emitting element including a cathode connected to the second power line and supplied with a cathode voltage Vss, and emits light according to the flow of the above-described signal current via the driving transistor 11a.

The switching transistor 11d is a switching transistor including a gate connected to the gate signal line 217b, and a source and a drain terminal one of which is connected to the drain terminal of the driving transistor 11a. The switching transistor 11d is formed of, for example, an n-type thin film transistor (n-type TFT).

The capacitor 19a first stores a source potential of the driving transistor 11a (potential of the source signal line 18) in a steady state, while the switching transistor 11b is in a conducting state. After that, the potential of the capacitor 19a is determined even when the switching transistor 11b is brought into an OFF state, and thus a gate voltage of the driving transistor 11a is determined.

It should be noted that the capacitor 19a is formed or disposed so as to overlap (stack) with the source signal line 18 and the gate signal line 17. In this case, layout flexibility is improved, a wider space can be secured between elements, and yield is improved.

Furthermore, the image display apparatus includes the source signal lines 18 for the total number of pixel columns. The gate signal lines 17 are connected to the gate driver ICs 12 and each of the EL elements 15 which belong to pixel rows including the EL elements 15. With this, the gate signal lines 17 each have a function of supplying each of the EL elements 15 which belong to the pixel row including the pixel 16 with a timing of writing the above-described signal voltage, and a function of supplying a timing of applying the reference voltage to the gate of the driving transistor ha included by the EL element 15.

There are instances where the image display apparatus (EL display panel) requires the ON voltage (Von) of plural types, and the OFF voltage (Voff) of plural types. Other than that, an initial voltage (Vini), a reference voltage (Vref), and the like are required.

Such a configuration of the image display apparatus allows the image display apparatus to simultaneously perform writing and deleting of video on and from the display screen 20. Accordingly, there is no need to collectively display video after the end of writing as conventionally performed, and it is possible to display video for each row on the display screen 20 before the end of the writing.

In the pixel 16 illustrated in FIG. 21, the drain terminal of the N-channel driving transistor 11a is connected to the source terminal of the switching transistor 11d, and the drain terminal of the switching transistor 11d is connected to the anode terminal of the EL element 15. An anode voltage Vdd is applied or supplied to the anode terminal.

It should be noted that the channel of the transistors 11 are bidirectional and the names of the source terminal and the drain terminal are for facilitating the explanation, and thus the source terminal and the drain terminal may be switched with each other. In addition, the names of the source terminal and the drain terminal are for convenience or for facilitating the explanation, and the source terminals and the drain terminals of transistors other than the driving transistor 11a may be referred to as the first terminal and the second terminal, for example. Furthermore, although the transistors 11 are explained as the N-channel transistors, the transistors 11 may be the P-channel transistors.

In addition, a cathode voltage Vss is applied to the cathode terminal of the EL element 15. The source terminal of the driving transistor 11a is electrically connected to the anode voltage terminal of the EL element 15. The source terminal of the switching transistor 11c is electrically connected to the source terminal of the driving transistor 11a. Furthermore, the drain terminal of the switching transistor 11c is applied or supplied with the initial voltage Vini.

It should be noted that an electrically connected state is a state in which a voltage pathway or a current pathway is formed or can be formed. For example, the first transistor and the second transistor are electrically connected even when a third transistor is disposed between the first transistor and the second transistor. In addition, in the Description of the present disclosure, there are instances where the term connect means electrically connect.

The source terminal of the switching transistor 11b is connected to the gate terminal of the driving transistor 11a, and the drain terminal of the switching transistor 11b is connected to the source signal line 18. The source terminal of the switching transistor 11e is connected to the gate terminal of the driving transistor 11a, and the drain terminal of the switching transistor 11e is applied or supplied with the reference voltage Vref.

The capacitor 19 is connected between the gate terminal of the driving transistor 11a and the source terminal of the driving transistor 11a.

It should be noted that, in the embodiment as illustrated in FIG. 21 and the like, the following relationship is preferable: anode voltage Vdd>reference voltage Vref>cathode voltage Vss>initial voltage Vini. More specifically, for example, anode voltage Vdd=10 to 18 (V), reference voltage Vref=1.5 to 3 (V), cathode voltage Vss=0.5 to 2.5 (V) and initial voltage Vini=0 to −3 (V).

It should be noted that the switching transistor 11d may be disposed or formed between the source terminal of the driving transistor 11a and the anode terminal of the EL element 15.

The gate terminal of the switching transistor 11d is connected to the gate signal line 17b. The gate terminal of the switching transistor 11e is connected to the gate signal line 17c. The gate terminal of the switching transistor 11b is connected to the gate signal line 17a. The gate terminal of the switching transistor 11c is connected to the gate signal line 17d.

When an ON voltage is applied to the gate signal line 17b (GE), the switching transistor 11d is turned ON, and a light-emission current is supplied from the driving transistor 11a to the EL element 15. The EL element 15 emits light according to the magnitude of the light-emission current. The magnitude of the light-emission current is determined by applying a video signal that is applied to the source signal line 18, to the pixel 16 by the second switching transistor 11b.

One of the terminals of the capacitor 19 is connected to the gate terminal of the driving transistor 11a, and the other terminal of the capacitor 19 is connected to the source terminal of the driving transistor 11a. The drain terminal of the switching transistor 11b is connected to the source signal line 18. The source driver circuit 14 applies a video signal to the source signal line 18.

The gate signal lines 17a and 17b are connected to the gate driver ICs (12a and 12b) disposed on the left side and on the right side of the display screen 20. Furthermore, the gate signal lines 17c and 17d are connected to the gate driver IC 12a disposed on the left side of the display screen 20.

The gate driver ICs 12 apply a selection voltage (ON voltage Von) of a pixel to the gate signal line 17. When an ON voltage of the gate signal line 17b is applied, the switching transistor 11b is turned ON, and a video signal applied to the source signal line 18 is applied to the pixel 16.

The EL display panel includes the display screen 20 including pixels 16 each having the EL element 15 are disposed in a matrix.

The gate driver ICs 12 (12a and 12b) are connected to the ends of the gate signal lines 17a and 17b. The gate driver IC 12a is connected to one side of the gate signal lines 17c and 17d. The gate driver ICs 12 are each mounted on a chip of film (COF) which is not illustrated.

In the same manner as above, the source signal line 18 is connected to each of the pixels 16. One end of the source signal line 18 is connected to the source driver IC (source driver circuit) 14. The source driver IC 14 is mounted on the chip on Film (COF) 22 which is not illustrated.

The source driver IC 14 outputs the video signal and the video signal is applied or supplied to the source signal line 18.

3-1-2. Overall Configuration

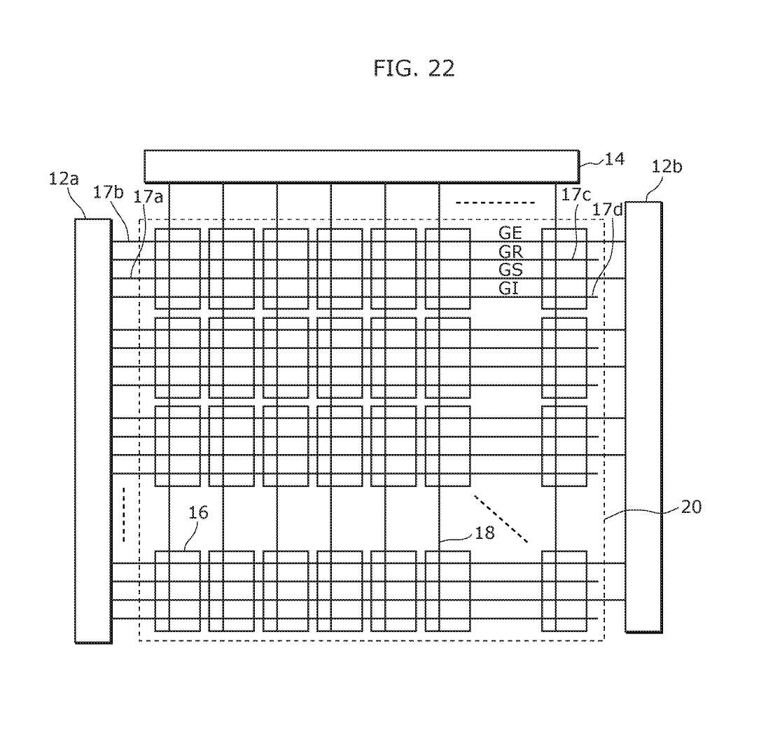

FIG. 22 is a diagram explaining the image display apparatus according to the present disclosure, in the case of the pixel configuration illustrated in FIG. 21. The gate driver ICs 12a and 12b apply the bilateral driving to the gate signal lines 17a and 17b. The gate driver IC 12a applies the unilateral driving to the gate signal lines 17c and 17d. The source driver circuit 14 generates a video signal voltage and applies the video signal voltage to the source signal line 18. The switching transistor 11b applies the video signal voltage applied to the source signal line 18, to the driving transistor 11a of the pixel 16.

### 3-2. Advantageous Effects Etc.

As described above, the image display apparatus according to the present modification which has the pixel configuration illustrated in FIG. 21 produces the same advantageous effect as Embodiment 2. More specifically, it is possible to use the gate driver ICs 12a and 12b which are highly versatile and can be used irrespective of the total number and arrangement of the gate signal lines 17 and irrespective of the specification or the like of the image display apparatus. In addition, it is possible to reduce the total number of the gate driver ICs 12b used, by a half of the total number of the gate driver ICs 12a used, making it possible to lower the costs.

### OTHER EMBODIMENTS

It should be noted that, although the bilateral driving is described as driving with the two gate driver ICs 12 disposed on the left side and the right side of the display screen 20, according to an embodiment of the present disclosure, the bilateral driving is not limited to this. The bilateral driving may be driving using one gate driver IC 12. For example, a system in which two gate driver ICs 12 are connected or disposed on one side of the gate signal line 17 and perform driving.

In other words, the bilateral driving is a system of driving one gate signal line 17 using a plurality of gate driver ICs 12. In addition, the gate signal lines 17 are described as being driven by the gate driver ICs 12, driving of the gate signal lines 17 is not limited to this. For example, a gate driver circuit (not illustrated) may be directly formed or disposed on an array substrate by a polysilicon technique and the gate signal lines 17 may be driven using the gate driver circuit.

Accordingly, a configuration in which the gate driver circuits are connected to the both ends of one gate signal line 17 is also included in a scope of the present disclosure. Furthermore, a configuration in which the gate driver IC 12 is connected to one end of one gate signal line 17, and the gate driver circuit is connected to the other end of the one gate signal line 17 is also included in a scope of the present disclosure. Furthermore, a configuration in which two gate driver circuits are connected to one end of one gate signal line 17 is also included in a scope of the present disclosure.

Furthermore, the present disclosure is not limited to the above-described image display apparatus, and may be implemented as a gate driver circuit for use in an image display apparatus including the display screen 20 in which the pixels 16 are disposed in a matrix.

More specifically, the gate driver IC 12 (gate driver circuit) according to an aspect of the present disclosure includes: a terminal CLK** (clock input terminal); a terminal STV** (data input terminal); a plurality of output terminals 34 connected to the gate signal lines 17 of the image display apparatus; and a setting unit (setting terminal FNC** and setting circuit 351) for setting a first mode or a second mode. In the first mode, the shift register circuit, etc. performs one shifting operation according to one clock input. In the second mode, the shift register circuit, etc. performs one shifting operation according to n clock inputs (n is an integer of at least 2). Here, the gate signal lines 17 are applied with a selection voltage (ON voltage) or a non-selection voltage (OFF voltage) output from the output terminals 34. The gate driver IC 12 (gate driver circuit) according to an aspect of the present disclosure is provided with, at the terminal STV** (data input terminal), data set at the terminal STV** (data input terminal) according to a clock inputted to the terminal CLK** (clock input terminal), the data is shifted in the gate driver IC 12 (gate driver circuit) in synchronization with the clock inputted into the terminal CLK** (clock input terminal), and a selection voltage or a non-selection voltage is output from the output terminal based on a data position in the gate driver IC 12 (gate driver circuit). When the terminal FNC** or the setting circuit 351 is set to the first mode, the data is shifted in the gate driver IC 12 (gate driver circuit) in synchronization with the clock inputted into the terminal CLK** (clock input terminal), and a selection voltage or a non-selection voltage is output based on a data position in the gate driver IC 12 (gate driver circuit). In contrast, when the terminal FNC** or the setting circuit 351 is set to the second mode, the data is shifted in the gate driver IC 12 (gate driver circuit) in synchronization with n clock cycles (n is an integer of at least 2) of a clock inputted to the terminal UK** (clock input terminal), and a selection voltage or a non-selection voltage is output based on a data position in the gate driver IC 12 (gate driver circuit).

In addition, the non-selection voltage may include a first non-selection voltage (Voff1 voltage, i.e., OFF voltage 1) and a second non-selection voltage (Voff2 voltage and OFF voltage 2), and an arbitrary output terminal 34 may output the second non-selection voltage (Voff2 voltage, i.e., OFF voltage 2) in a period of one clock cycle after the selection voltage is output, and the first non-selection voltage (Voff1 voltage, i.e., OFF voltage 1) after the second non-selection voltage (Voff2 voltage, i.e., OFF voltage 2) is output.

Furthermore, the gate driver IC 12 (gate driver circuit) may includes a plurality of scanning and outputting buffer circuits 31a and 31b (scanning circuits), and the scanning and outputting buffer circuits 31a and 31b (scanning circuits) may each include terminal CLK** (clock input unit) and the terminal STV** (data input unit).

Furthermore, the present disclosure may be implemented as an image display apparatus including the gate driver IC 12 (gate driver circuit) described above. More specifically, an image display apparatus according to another aspect of the present disclosure includes: the display screen 20 in which the pixels 16 are disposed in a matrix; the gate driver IC 12a (the first gate driver circuit) that is the above-described gate driver IC 12 (gate driver circuit) disposed on the first side of the display screen 20; and the gate driver IC 12b (the second gate driver circuit) that is the above-described gate driver IC 12 (gate driver circuit) disposed on the second side of the display screen 20. In addition, the gate driver IC 12 (gate driver circuit) includes the scanning and outputting buffer circuit 31a (the first scanning circuit) and the scanning and outputting buffer circuit 31b (the second scanning circuit). The scanning and outputting buffer circuit 31a (the first scanning circuit) is electrically connected to the terminal GE* (the first output terminal), and the scanning and outputting buffer circuit 31b (the second scanning circuit) is electrically connected to the terminal GS* (the second output terminal). Furthermore, the pixels 16 each include the gate signal line 17a (the first gate signal line) and the gate signal line 17b (the second gate signal line). The pixels 16 include the first pixel and the second pixel. The terminal GE* (the first output terminal) of the gate driver IC 12a (the first gate driver circuit) is electrically connected to the gate signal line 17a (the first gate signal line) of the first pixel. The terminal GE* (the first output terminal) of the gate driver IC 12a (the first gate driver circuit) is electrically connected to the gate signal line 17a (the first gate signal line) of the second pixel. The terminal GS* (the second output terminal) of the gate driver IC 12a (the first gate driver circuit) is electrically connected to the gate signal line 17b (the second gate signal line) of the first pixel. The terminal GS* (the second output terminal) of the gate driver IC 12a (the first gate driver circuit) is electrically connected to the gate signal line 17b (the second gate signal line) of the second pixel. The terminal GE* (the first output terminal) of the gate driver IC 12b (the second gate driver circuit) is electrically connected to the gate signal line 17a (the first gate signal line) of the first pixel. The terminal GS* (the second output terminal) of the gate driver IC 12b (the second gate driver circuit) is electrically connected to the gate signal line 17a (the first gate signal line) of the second pixel.

In addition, the present disclosure may be implemented as an image display apparatus as described below. An image display apparatus according to yet another aspect of the present disclosure is an image display apparatus of an active matrix type which includes the display screen 20 in which the pixels 16 are disposed in a matrix. The image display apparatus includes the gate driver IC 12a (the first gate driver circuit) and the gate driver IC 12b (the second gate driver circuit). Furthermore, the gate signal line 17a (the first gate signal line) and the gate signal line 17b (the second gate signal line) are formed on each of the pixels 16. The gate signal line 17a (the first gate signal line) has one end connected to the output terminal of the gate driver IC 12a (the first gate driver circuit) and the other end connected to the output terminal of the gate driver IC 12b (the second gate driver circuit). The gate signal line 17b (the second gate signal line) has one end connected to the output terminal of the gate driver IC 12a (the first gate driver circuit) and the other end is opened.

In addition, the present disclosure may be implemented as an image display apparatus as described below. An image display apparatus according to yet another aspect of the present disclosure includes: the display screen 20 in which the pixels 16 are disposed in a matrix; the source driver IC 14 (the source driver circuit) which outputs a video signal to be applied to the pixels 16; the source signal lines 18 which transmit the video signal output by the source driver IC 14 (source driver circuit); the gate driver IC 12a (the first gate driver circuit); the gate driver IC 12b (the second gate driver circuit); and the gate signal line 17a (first gate signal line) and the gate signal line 17b (the second gate signal line) each of which transmits a selection voltage for selecting a pixel from among the pixels 16 or a non-selection transmit for placing a pixel among the pixels 16 in a non-selection state. In addition, the gate driver IC 12a (the first gate driver circuit) and the gate driver IC 12b (the second gate driver circuit) select one of the non-selection voltage and the selection voltage, and output the selected voltage to the gate signal line 17a (the first gate signal line) and the gate signal line 17b (the second gate signal line). The scanning and outputting buffer circuits 31a and 31b (scanning circuits) of the gate driver IC 12a (the first gate driver circuit) operate in synchronization with one clock cycle of an input clock. The scanning and outputting buffer circuits 31a and 31b (scanning circuits) of the gate driver IC 12b (the second gate driver circuit) operate in synchronization with n clock cycles (n is an integer of at least 2) of an input clock.

For example, the gate driver IC 12a (the first gate driver circuit) may be disposed on the first side of the display screen 20, and the gate driver IC 12b (the second gate driver circuit) may be disposed on the second side of the display screen 20 which is different from the first side of the display screen 20.

In addition, for example, the non-selection voltage may include the first non-selection voltage (Voff1 voltage and, i.e., OFF voltage 1) and the second non-selection voltage (Voff2 voltage, i.e., OFF voltage 2), and the second non-selection voltage (Voff2 voltage, i.e., OFF voltage 2) may be output to one of the output terminals 34 in a period of one clock cycle after the selection voltage has been output to the one of the output terminals 34, and the first non-selection voltage (Voff1 voltage, i.e., OFF voltage 1) may be output to the one of the output terminals 34 after the second non-selection voltage (Voff2 voltage, i.e., OFF voltage 2) has been output to the one of the output terminals 34.

In addition, for example, the EL element 15 and the driving transistor 11a for supplying current to the EL element 15 may be formed on the each of the pixels 16.

Furthermore, for example, the gate driver IC 12a (the first gate driver circuit) may be disposed on the first side of the display screen 20, and the gate driver IC 12b (the second gate driver circuit) may be disposed on the second side of the display screen 20 which is different from the first side of the display screen 20. The gate driver ICs 12 (the gate driver circuits) may be driver ICs. The total number of the gate driver ICs 12a (the first gate driver circuits) may be larger than the total number of the gate driver ICs 12b (the second gate driver circuits).

The present disclosure has been described mainly illustrating the system of applying a video signal voltage to the pixels 16 (program voltage system). However, the present disclosure is not limited to this system. A system of applying a video signal current to the pixels 16 (program current system) may be employed. In addition, as in the PWM driving, a digital driving system in which the pixels 16 are caused to blink or digitally emit light for display may be employed. Moreover, other driving systems may be employed. Light-emitting area variable driving which expresses the intensity of light emission by the light-emission area may be employed.

For example, as the PWM driving, a system is exemplified which a predetermined voltage value is applied to the pixels 16 by the transistor 11b, and tuning ON and OFF the transistor 11d for a period corresponding to a bit number indicated by the gradation to implement gradation expression.

In addition, with the ON and OFF control on the transistor 11d, a belt-like black display (not illustrated) is generated on the display screen 20 and an amount of current that flows through the display screen 20 is controlled.

Furthermore, it is preferable that the anode voltage Vdd is variable based on the magnitude of current flowing through the display screen 20. When the current flowing through the display screen 20 is greater than a predetermined value, the anode voltage Vdd is decreased so that the power consumption of the panel is suppressed. When the current flowing through the display screen 20 is smaller than a predetermined value, the anode voltage Vdd is increased or caused to hold a predetermined voltage so that a specified current flows through the EL element 15 of each of the pixels 16.

It is possible to apply, to various electronic devices, the details (or part of the details) described in each of the diagrams of the above-described embodiments. To be specific, it is possible to apply them to display units of electronic devices.

Examples of such electronic devices include: a video camera, a digital camera, a head mounted display, a navigation system, an audio reproducing device (a car audio, an audio component, etc.), a computer, a gaming device, a mobile information terminal (a mobile computer, a mobile phone, a mobile gaming device, a digital book, etc.), an image reproducing apparatus including a recording medium [to be specific, a device including a display capable of reproducing a recording medium of a digital versatile disc (DVD) or the like and displaying the image thereof], etc.

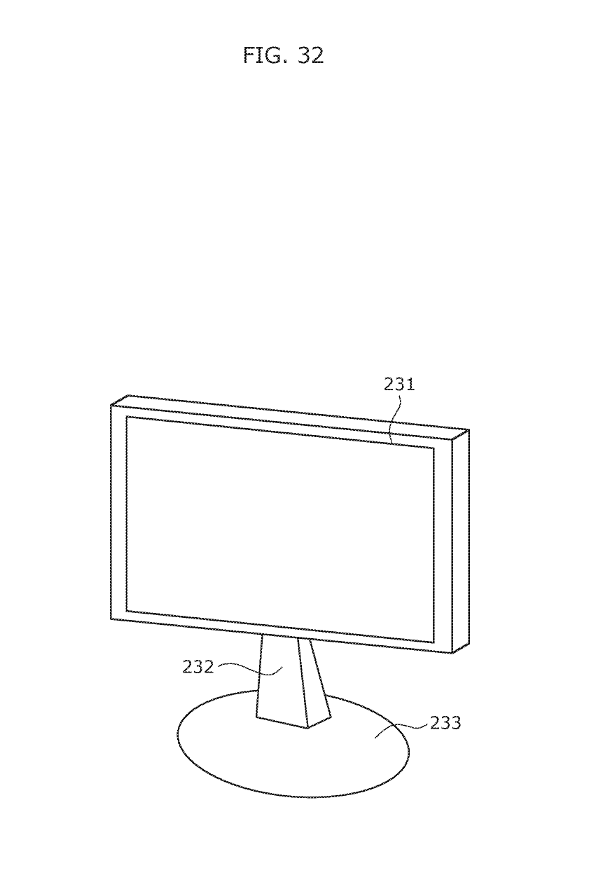

FIG. 32 illustrates a display (image display apparatus) including: a support column 232; holding base 233; and the image display apparatus (EL display panel) 231 according to the present disclosure. The display illustrated in FIG. 32 has a function of displaying various information items (a still image, video, a text image, etc.) on a display portion. It should be noted that the function of the display illustrated in FIG. 32 is not limited to this, and the display can have various functions.

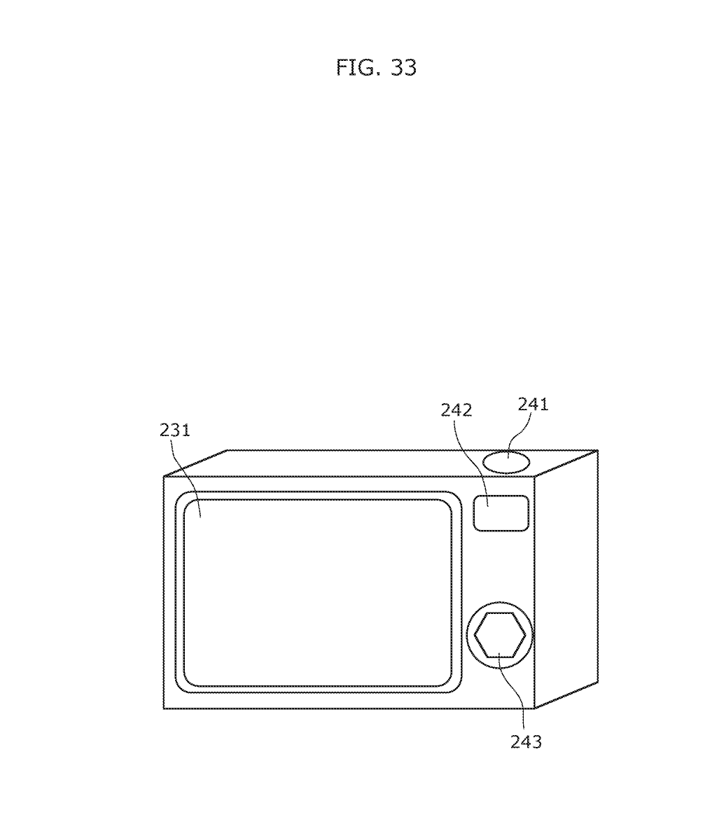

FIG. 33 illustrates a camera including: a shutter 241; a viewfinder 242; and a cursor 243. The camera illustrated in FIG. 33 has a function of capturing a still image. The camera also has a function of capturing video. It should be noted that the functions of the camera illustrated in FIG. 33 are not limited to these functions, and the camera can have various functions.

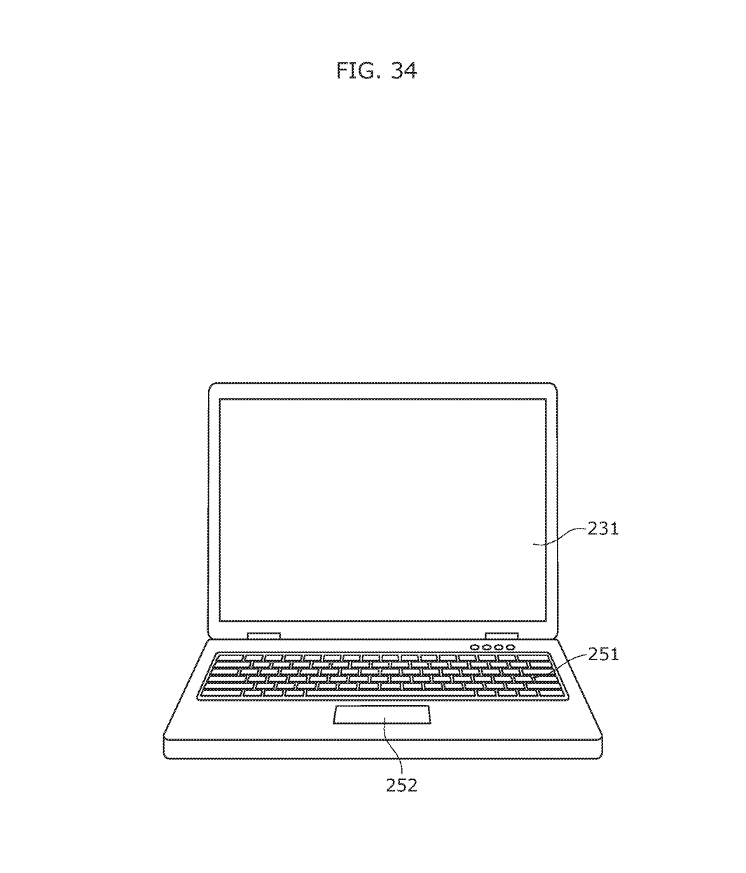

FIG. 34 illustrates a computer including: a keyboard 251; and a touch-pad 252. The computer illustrated in FIG. 34 has a function of displaying various information items (a still image, video, a text image, etc.) on a display portion. It should be noted that the function of the computer illustrated in FIG. 34 is not limited to this, and the computer can have various functions.

It should be understood that the above-described embodiment can also be applied to the other embodiments according to the present disclosure. It should also be understood that it is possible to combine the above-described embodiment and modification with other embodiments.

It is possible to upgrade the image quality of the above-described information devices illustrated in the above-described FIG. 32 to FIG. 34, by employing the image display apparatus (EL display panel) or the driving system described in the above-described embodiments in the configuration of the display portion of the present embodiment. In addition, it is possible to easily perform a test or adjustment.

It is possible to arbitrarily combine the above-described embodiments with other embodiments.

In the present disclosure, each drawings has a portion which is omitted, enlarged, or reduced, for facilitating understanding or facilitating drawing of the figures.

Items or details illustrated or described in each of the embodiments of the present disclosure are applied to other embodiments as well. In addition, the EL display panel described or illustrated in the embodiments of the present disclosure can be adopted as the image display apparatus of the present disclosure.

For example, it should be understood that the image display apparatus (EL display panel) illustrated or explained in the above-described embodiments of the present disclosure can be employed as the image display apparatus 231 of the laptop personal computer illustrated in FIG. 34, or can be included in information devices.

Furthermore, portions to which the same numbers or symbols are assigned have the same or similar forms, materials, functions, operations, related items, effects, etc.

The details described in each of the diagrams or the like can be combined with other embodiments, etc., without notification. For example, it is possible to form an information display apparatus or the like illustrated in FIG. 32, FIG. 33 and FIG. 34, by adding a touch panel or the like to the EL display panel according to the present disclosure illustrated in FIG. 1.

The image display apparatus according to the present disclosure is a concept which includes a system device such as an information device. The concept of the EL display panel includes, in a broad sense, a system device such as an information device.

In addition, although it is stated, in the embodiments and the modifications described above, that the total number of the gate driver ICs 12b required may be half of the total number of the gate driver ICs 12a required, the total number of the gate driver ICs 12b is not limited to this.

For example, in the case where four types of the gate signal lines 17 (17a, 17b, 17c, and 17d) are disposed or formed in each of the pixels, four scanning and outputting buffer circuits 31 (31a, 31b, 31c, and 31d) are formed in each of the gate driver ICs 12, the bilateral driving is applied to the gate signal line 17a, and the unilateral driving is applied to the other gate signal lines 17 (17b, 17c, and 17d), the total number of the gate driver ICs 12b is one fourth of the total number of the gate driver ICs 12a according to the configuration illustrated in FIG. 1.

As described above, according to the present disclosure, the total number of the gate driver ICs 12 is determined based on the types (total numbers) of the gate signal lines 17 in each of the pixels, whether the bilateral driving or the unilateral driving is applied to the gate signal lines 17, and the total number of the scanning and outputting buffer circuits 31 included in the gate driver ICs 12.

The scanning and outputting buffer circuit 31a in the gate driver IC 12b drives the gate signal line 17a in the 4n−3th pixel row (n is an integer of at least 1), the scanning and outputting buffer circuit 31b drives the gate signal line 17a in the 4n−2th pixel row (n is an integer of at least 1), the scanning and outputting buffer circuit 31c drives the gate signal line 17a in the 4n−1th pixel row (n is an integer of at least 1), and the scanning and outputting buffer circuit 31d drives the gate signal line 17a in the 4n-th pixel row (n is an integer of at least 1).

As described above, the total number of the gate driver IC 12a; that is, one of the gate driver ICs is equal to the integral multiple of the total number of the gate driver IC 12b; that is, the other of the gate driver ICs.

In addition, when the types of the gate signal lines 17 in each of the pixels is m, and the total number of the gate signal lines 17, among the m types of the gate signal lines 17, to which the bilateral driving is performed is n (n<m), the total number of one of the gate driver ICs 12a used is equal to the m n multiple of the total number of the gate driver ICs 12b; that is, the other of the gate driver ICs.

As described above, the embodiments are described as exemplifications of the technique according to the present disclosure. The accompanying drawings and detailed description are provided for this purpose.

Therefore, the constituent elements described in the accompanying drawings and detailed description include, not only the constituent elements essential to solving the problem, but also the constituent elements that are not essential to solving the problem but are included in order to exemplify the aforementioned technique. As such, description of these non-essential constituent elements in the accompanying drawings and the detailed description should not be taken to mean that these non-essential constituent elements are essential.

Furthermore, since the foregoing embodiments are for exemplifying the technique according to the present disclosure, various changes, substitutions, additions, omissions, and so on, can be carried out within the scope of the Claims or its equivalents.

### INDUSTRIAL APPLICABILITY

The present disclosure can be applied to an image display apparatus (EL display panel) and a driving method thereof, and more specifically, to a television set, a camera, and a display of a computer, etc.

### REFERENCE SIGNS LIST

11, 11a, 11b, 11c, 11d, 11e, 93, 93a, 93b, 93c, transistor (TFT)
12, 12a, 12b gate driver IC (i.e., gate driver circuit)
14 source driver IC (i.e., source driver circuit)
15 EL element
16, 16a, 16b, 16c, pixel
17, 17a, 17b, 17c, 17d, gate signal line
18 source signal line
19, 19a, 19b capacitor
20 display screen
21 display panel
22 COF
23, 23a to 23c printed circuit board
31, 31a, 31b, 31c, 31d, scanning and outputting buffer circuit
34 output terminal
35 connecting terminal
61 switching circuit
91, 91a, 91b shift register circuit
92 selecting circuit
94 outputting buffer circuit
231 EL display panel (i.e., image display apparatus)
232 support column
233 holding base
241 shutter
242 viewfinder
243 cursor
251 keyboard
252 touch-pad

1. A gate driver circuit included in an image display apparatus that includes a display screen in which pixels are disposed in a matrix, the gate driver circuit comprising:
a clock input terminal;
a data input terminal;
a plurality of output terminals connected to gate signal lines of the image display apparatus; and
a setting circuit for setting a first mode or a second mode,
wherein a selection voltage or a non-selection voltage output from an arbitrary one of the plurality of output terminals is applied to a corresponding one of the gate signal lines,
data set at the data input terminal is provided to the gate driver circuit according to a clock inputted to the clock input terminal,
the data is shifted in the gate driver circuit in synchronization with the clock inputted to the clock input terminal,
the arbitrary one of the plurality of output terminals outputs the selection voltage or the non-selection voltage based on a data position in the gate driver circuit,
when the setting circuit is set to the first mode,
the data is shifted in the gate driver circuit in synchronization with one clock cycle of the clock inputted to the clock input terminal, and the selection voltage or the non-selection voltage is output based on the data position in the gate driver circuit, and
when the setting circuit is set to the second mode,
the data is shifted in the gate driver circuit in synchronization with n clock cycles of the clock inputted to the clock input terminal, and the selection voltage or the non-selection voltage is output based on the data position in the gate driver circuit, n being an integer of at least 2.

2. The gate driver circuit according to claim 1,
wherein the non-selection voltage includes a first non-selection voltage and a second non-selection voltage, and
the arbitrary one of the plurality of output terminals
outputs the second non-selection voltage in a period of the one clock cycle after the selection voltage has been output, and
outputs the first non-selection voltage after the second non-selection voltage has been output.

3. The gate driver circuit according to claim 1, comprising
a plurality of scanning circuits each including a clock input unit and a data input unit.

4. An image display apparatus comprising:
a display screen including pixels disposed in a matrix;
a first gate driver circuit which is the gate driver circuit according to claim 1, and is disposed on a first side of the display screen; and
a second gate driver circuit which is the gate driver circuit according to claim 1, and is disposed on a second side of the display screen which is different from the first side of the display screen,
wherein the gate driver circuit includes a first scanning circuit and a second scanning circuit,
the plurality of output terminals include a first output terminal and a second output terminal,
the first scanning circuit is electrically connected to the first output terminal,
the second scanning circuit is electrically connected to the second output terminal,
the pixels each include a first gate signal line and a second gate signal line,
the pixels include a first pixel and a second pixel,
the first output terminal of the first gate driver circuit is electrically connected to the first gate signal line of the first pixel,
the first output terminal of the first gate driver circuit is electrically connected to the first gate signal line of the second pixel,
the second output terminal of the first gate driver circuit is electrically connected to the second gate signal line of the first pixel,
the second output terminal of the first gate driver circuit is electrically connected to the second gate signal line of the second pixel,
the first output terminal of the second gate driver circuit is electrically connected to the first gate signal line of the first pixel, and
the second output terminal of the second gate driver circuit is electrically connected to the first gate signal line of the second pixel.

5. An image display apparatus of an active matrix type which includes a display screen in which pixels are disposed in a matrix, the image display apparatus comprising
a first gate driver circuit and a second gate driver circuit,
wherein the pixels each include a first gate signal line and a second gate signal line,
the first gate signal line has an end connected to an output terminal of the first gate driver circuit,
the first gate signal line has an other end connected to an output terminal of the second gate driver circuit,
the second gate signal line has an end connected to an output terminal of the first gate driver circuit, and
the second gate signal line has an other end that is opened.

6. An image display apparatus comprising:
a display screen including pixels disposed in a matrix;
a source driver circuit which outputs a video signal to be applied to the pixels;
a source signal line which transmits the video signal output by the source driver circuit;
a first gate driver circuit;
a second gate driver circuit; and
a first gate signal line and a second gate signal line each of which transmits a selection voltage for selecting a pixel from among the pixels and a non-selection voltage for placing a pixel among the pixels in a non-selection state,
wherein the first gate driver circuit and the second gate driver circuit each select one of the non-selection voltage and the selection voltage, and output the selected one of the non-selection voltage and the selection voltage to the first gate signal line and the second gate signal line,
the first gate driver circuit includes a scanning circuit which operates in synchronization with one clock cycle of a clock inputted, and
the second gate driver circuit includes a scanning circuit which operates in synchronization with n clock cycles of a clock inputted, the n being an integer of at least 2.

7. The image display apparatus according to claim 5,
wherein the first gate driver circuit is disposed on a first side of the display screen, and
the second gate driver circuit is disposed on a second side of the display screen which is different from the first side of the display screen.

8. The image display apparatus according to claim 4,
wherein the non-selection voltage includes a first non-selection voltage and a second non-selection voltage, and
the second non-selection voltage is output to an arbitrary one of the plurality of output terminals in a period of one clock cycle after the selection voltage has been output to the arbitrary one of the plurality of output terminals, and
the first non-selection voltage is output to the arbitrary one of the plurality of output terminals after the second non-selection voltage has been output to the arbitrary one of the plurality of output terminals.

9. The image display apparatus according to claim 4,
wherein the pixels each include an electroluminescence (EL) element and a driving transistor which supplies current to the EL element.

10. The image display apparatus according to claim 5,
wherein the first gate driver circuit is disposed on a first side of the display screen,
the second gate driver circuit is disposed on a second side of the display screen which is different from the first side of the display screen,
the first gate driver circuit and the second gate driver circuit are each a driver integrated circuit (IC), and
a total number of the first gate driver circuits is larger than a total number of the second gate driver circuits.

11. The image display apparatus according to claim 6,
wherein the first gate driver circuit is disposed on a first side of the display screen, and
the second gate driver circuit is disposed on a second side of the display screen which is different from the first side of the display screen.

12. The image display apparatus according to claim 5,
wherein the non-selection voltage includes a first non-selection voltage and a second non-selection voltage, and
the second non-selection voltage is output to an arbitrary one of the plurality of output terminals in a period of one clock cycle after the selection voltage has been output to the arbitrary one of the plurality of output terminals, and
the first non-selection voltage is output to the arbitrary one of the plurality of output terminals after the second non-selection voltage has been output to the arbitrary one of the plurality of output terminals.

13. The image display apparatus according to claim 5,
wherein the pixels each include an electroluminescence (EL) element and a driving transistor which supplies current to the EL element.

14. The image display apparatus according to claim 6,
wherein the first gate driver circuit is disposed on a first side of the display screen,
the second gate driver circuit is disposed on a second side of the display screen which is different from the first side of the display screen,
the first gate driver circuit and the second gate driver circuit are each a driver integrated circuit (IC), and
a total number of the first gate driver circuits is larger than a total number of the second gate driver circuits.

15. The image display apparatus according to claim 6,
wherein the non-selection voltage includes a first non-selection voltage and a second non-selection voltage, and
the second non-selection voltage is output to an arbitrary one of the plurality of output terminals in a period of one clock cycle after the selection voltage has been output to the arbitrary one of the plurality of output terminals, and
the first non-selection voltage is output to the arbitrary one of the plurality of output terminals after the second non-selection voltage has been output to the arbitrary one of the plurality of output terminals.

16. The image display apparatus according to claim 6,
wherein the pixels each include an electroluminescence (EL) element and a driving transistor which supplies current to the EL element.
